(19) United States
(12) Patent Application Publication
(10) Pub. No.: US 2024/0231583 A9
(43) Pub. Date: Jul. 11, 2024

(54) DOCUMENT RELATIONSHIP QUERY METHOD, SEARCH METHOD, APPARATUS, AND ELECTRONIC DEVICE

(71) Applicant: BEIJING ZITIAO NETWORK TECHNOLOGY CO., LTD., Beijijg (CN)

(72) Inventors: Angeline Lim Sze YUIN, Beijing (CN); Yuzhen CAI, Beijing (CN)

(21) Appl. No.: 18/279,788

(22) PCT Filed: Mar. 1, 2022
(86) PCT No.: PCT/CN2022/078514

§ 371 Date: Aug. 31, 2023

(30) Foreign Application Priority Data
Mar. 1, 2021 (CN) 202110227774.8
Mar. 1, 2021 (CN) 202110227784.1

(51) Int. Cl. G06F 3/04845; G06F 3/0483; G06F 3/04842

(52) U.S. Cl. CPC G06F 3/04845; G06F 3/0483; G06F 3/04842

(57) ABSTRACT

A document relationship query method is provided, comprising: determining a first document displayed in the target page; displaying a relationship chart, in a first region of the target page, of the first document and a second document, and displaying the content of the first document in a second region of the target page, the first document and the second document having a first association relationship or a second association relationship. A document search method is provided, comprising: acquiring a first document corresponding to the search request; displaying, in a first region in a page, a relationship chart of the first document and a second document, and displaying first information of the first document and/or second information of the second document in a second region in the page, the first document and the second document have a first association relationship or a second association relationship.

This application claims priority to the following Chinese Patent Application, both of which are incorporated herein by reference in their entireties:
1. Chinese Patent Application No. 202110227784.1, titled “DOCUMENT RELAfIONSHIP QUERY METHOD, APPARATUS, ELECTRONIC DEVICE, AND STORAGE MEDIUM”, filed on Mar. 1, 2021, with the China National Intellectual Property Administration; and
2. Chinese Patent Application No. 202110227774.8, titled “DOCUMENT SEARCH METHOD, APPARATUS, ELECTRONIC DEVICE, AND STORAGE MEDIUM”, filed on Mar. 1, 2021, with the China National Intellectual Property Administration.

### FIELD

The present disclosure relates to the field of computer technology, and in particular to a method and an apparatus for searching for a document, an electronic device, and a storage medium.

### BACKGROUND

Conventionally, a user views an online document through document management application software. An existing document management application program generally displays only the document to be viewed by user. The user cannot understand an association relationship of a currently-viewed document and another document from the single display content.

The document management application program may provide the user with a function of searching for a document by using a keyword. In existing technologies, document information of the document obtained through the searching is displayed to the user. The user cannot understand an association relationship of the obtained document and other documents from the single display mode.

### SUMMARY

A method and an apparatus for querying a relationship of documents, an electronic device, and a storage medium are provided in embodiments of the present disclosure, with which convenience for a user to view an association relationship among different documents is improved.

In a first aspect, a method for querying a relationship of documents is provided according to an embodiment of the present disclosure. The method includes: determining a first document displayed on a target page in response to a document relationship query operation performed by a user on the target page, where content of the first document is displayed on the target page; displaying, in a first area of the target page, a relationship diagram for the first document and a second document; and displaying, in a second area of the target page, the content of the first document, where the first document is in a first association relationship or a second association relationship with the second document.

In a second aspect, an apparatus for querying a relationship of documents is provided according to an embodiment of the present disclosure. The apparatus includes: a determination module, configured to determine a first document displayed on a target page in response to a document relationship query operation performed by a user on the target page, where content of the first document is displayed on the target page; and a first display module, configured to display, in a first area of the target page, a relationship diagram for the first document and a second document, and display, in a second area of the target page, the content of the first document, where the first document is in a first association relationship or a second association relationship with the second document.

In a third aspect, a method for searching for a document is provided according to an embodiment of the present disclosure. The method includes: obtaining, in response to a search request, a first document corresponding to the search request; displaying, in a first area of a page, a relationship diagram for the first document and a second document; and displaying, in a second area of the page, at least one of first information of the first document and second information of the second document, where the first document is in a first association relationship or a second association relationship with the second document.

In a fourth aspect, an apparatus for searching for a document is provided according to an embodiment of the present disclosure. The apparatus includes: an obtaining module, configured to obtain, in response to a search request, a first document corresponding to the search request; and a display module, configured to display, in a first area of a page, a relationship diagram for the first document and a second document, and display, in a second area of the page, at least one of first information of the first document and second information of the second document, where the first document is in a first association relationship or a second association relationship with the second document.

In a fifth aspect, an electronic device is provided according to an embodiment of the present disclosure. The electronic device includes: one or more processors; and a memory storing one or more programs. The one or more programs, when executed by the one or more processors, cause the one or more processors to perform the method for querying a relationship of documents or the method for searching for a document, as described in the embodiments of the present disclosure.

In a sixth aspect, a computer-readable storage medium, storing a computer program, is provided according to an embodiment of the present disclosure. The computer program, when executed by a processor, implements the method for querying a relationship of documents or the method for searching for a document, as described in the embodiments of the present disclosure.

With the method and the apparatus for querying a relationship of documents, the electronic device and the storage medium according to the embodiments of the present disclosure, a first document displayed on the target page is determined in response to the document relationship query operation performed by a user on the target page, where content of the first document is displayed on the target page; the relationship diagram for the first document and the second document is displayed in the first area of the target page, where the first document is in the first association relationship or the second association relationship with the second document; and the content of the first document is displayed in the second area of the target page. With this technical solution, both content of a document and an association relationship between the document and other documents can be displayed. Therefore, the user is enabled to view a document associated with the first document pointedly based on the association relationship, and thereby user experience is improved.

The method and the apparatus for searching for a document, the electronic device, and the storage medium according to the embodiments of the present disclosure are provided, in order to display, to a user, a document that the user is searching for and an association relationship between the document and other documents. With the method and the apparatus for searching for a document, the electronic device, and the storage medium according to the embodiments of the present disclosure, the first document corresponding to the search request is obtained in response to the search request; a relationship diagram for the first document and a second document is displayed in the first area of the page, where the first document is in a first association relationship or a second association relationship with the second document; and first information of the first document and second information of the second document are displayed in the second area of the page. With this technical solution, in a case that the to user searches for a document, information of the document, an association relationship between the document and other documents, and information of a document which is in the association relationship with the document are all displayed. Therefore, the user is enabled to view the association relationship of the document that the user is searching for and other documents while viewing the document that the user is searching for. Thereby, the user can view other documents associated with the document obtained through searching pointedly based on the association relationship, and user experience is improved.

### BRIEF DESCRIPTION OF THE DRAWINGS

The above and other features, advantages and aspects of the various embodiments of the present disclosure will become more apparent with reference to the following detailed description in conjunction with the drawings. Throughout the drawings, the same or similar reference numerals denote the same or similar elements. It should be understood that the drawings are schematic and that components and elements are not necessarily drawn to scale.

FIG. 1 is a flowchart of a method for querying a relationship of documents according to an embodiment of the present disclosure;

FIG. 2 is a schematic diagram of a display mode of a target page according to an embodiment of the present disclosure;

FIG. 3 is a schematic diagram of a display mode of a target page according to another embodiment of the present disclosure;

FIG. 4 is a schematic diagram of a display mode of a node according to an embodiment of the present disclosure;

FIG. 5 is a flowchart of a method for querying a relationship of documents according to another embodiment of the present disclosure;

FIG. 6 is a schematic diagram of a display mode of a target page according to yet another embodiment of the present disclosure;

FIG. 7 is a schematic diagram of a display mode of a node according to another embodiment of the present disclosure;

FIG. 8 is a structural block diagram of an apparatus for querying a relationship of documents according to an embodiment of the present disclosure;

FIG. 9 is a schematic structural diagram of an electronic device according to an embodiment of the present disclosure;

FIG. 10 is a flowchart of a method for searching for a document according to an embodiment of the present disclosure;

FIG. 11 is a schematic diagram of a page according to an embodiment of the present disclosure:

FIG. 12 is a schematic diagram of a display mode of a node according to an embodiment of the present disclosure;

FIG. 13 is a flowchart of a method for searching for a document according to another embodiment of the present disclosure;

FIG. 14 is a schematic relationship diagram according to an embodiment of the present disclosure;

FIG. 15 is a schematic diagram of a display mode of a node according to another embodiment of the present disclosure;

FIG. 16 is a schematic diagram of a page according to an embodiment of the present disclosure;

FIG. 17 is a structural block diagram of an apparatus for searching for a document according to an embodiment of the present disclosure;

FIG. 18 is a schematic structural diagram of an electronic device according to an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be embodied in various forms and should not be construed as limited to the embodiments set forth herein. Instead, these examples are provided so that the understanding of the present disclosure can be thorough and complete. It should be understood that the drawings and embodiments of the present disclosure are for illustrative purposes only, and are not intended to limit the protection scope of the present disclosure.

It should be understood that the various steps described in the method embodiments of the present disclosure may be performed in different orders, and/or performed in parallel. Additionally, method embodiments may include additional steps and/or illustrated steps may be not performed. The scope of the present disclosure is not limited in this regard.

The terms “comprising” and variations thereof herein are non-exclusive, meaning “including but not limited to”. The term “based on” means “based at least in part on”. The term “one embodiment” means “at least one embodiment.” The term “another embodiment” means “at least one further embodiment”. The term “some embodiments” means “at least some embodiments.” Relevant definitions of other terms will be given in the description below.

It should be noted that concepts such as “first” and “second” mentioned herein are only for distinguishing among different devices, modules or units, rather than limiting the sequence or interdependence of functions performed by these devices, modules or units.

It should be noted that the determiners of “a” and “multiple” mentioned in the present disclosure are illustrative rather than restrictive. Those skilled in the art should understand that, unless the context clearly indicates otherwise, such determiners should be understood as “one or more”.

The names of messages or information exchanged between multiple devices in the embodiments of the present disclosure are used for illustrative purposes only, and are not used to limit the scope of these messages or information.

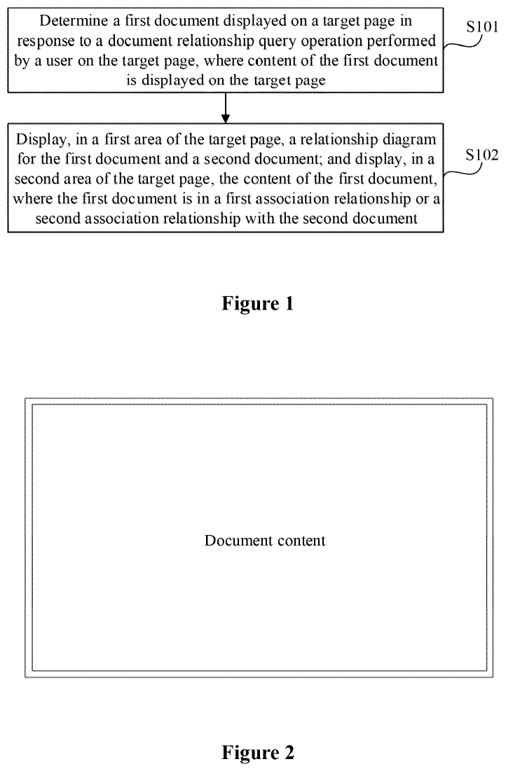

FIG. 1 is a schematic flowchart of a method for querying a relationship of documents according to an embodiment of the present disclosure. The method may be performed by an apparatus for querying a relationship of documents. The apparatus may be implemented by software and/or hardware, and may be integrated in an electronic device. Typically, the apparatus may be configured in a computer device. The method for querying a relationship of documents provided in the embodiments of the present disclosure is applicable to a scene of querying a document relationship of a document currently viewed. As shown in FIG. 1, the method provided in the present disclosure may include the following steps S101 to S102.

In S101, a first document displayed on a target page is determined in response to a document relationship query operation performed by a user on the target page, where content of the first document is displayed on the target page.

The document relationship query operation may be understood as a trigger operation for querying an association relationship between a certain document and other documents. For example, the document relationship query operation may be clicking a relationship diagram control displayed on the target page. The target page may be a page for a user to perform the document relationship query operation, and may be a document display page. The first document represents a document displayed on the target page.

In an embodiment, the user, while viewing content of a certain document, may perform a document relationship query operation to query an association relationship between a currently-viewed document and other documents and/or determine a document having an association relationship with the currently-viewed document. As shown in FIG. 2, an electronic device displays the target page in response to a trigger operation from the user, and displays, on the target page, content of a first document that the user hopes to view. The user views the content of the first document through the target page. In a case that the user hopes to view a document relationship of the first document, the user may perform a document relationship query operation, for example, by clicking a relationship diagram control on the target page (not shown in FIG. 2). The electronic device determines reception of the document relationship query operation on detecting that the user clicks the relationship diagram control on the target page, and determines a currently-displayed document on the target page, i.e., the first document, in response to the document relationship query operation.

In S102, a relationship diagram for the first document and a second document is displayed in a first area of the target page, and the content of the first document is displayed in a second area of the target page, where the first document is in a first association relationship or a second association relationship with the second document.

The first area and the second area may be two display areas within the page. The first area may be for displaying the relationship diagram for the first document and the second document. The second area may be for displaying the content of the first document. The second document may have the first association relationship or the second association relationship with the first document. The second document may be in a quantity of one or more. The relationship diagram for the first document and the second document may be understood as a graph characterizing an association relationship between the first document and the second document. The relationship diagram may display only the association relationship between the first document and the second document, or may further display an association relationship between the first document and another document. For example, the relationship diagram may be a document map of a document space to which the first document belongs. The document map may present an association relationship among all documents in the document space to which the first document belongs. Nodes for the documents in an association relationship may be connected by lines. The following description is made by taking this situation as an example. In addition, document names of the documents corresponding to the nodes may be further displayed in the relationship diagram for the first document and the second document, so that the user can distinguish the documents to which the nodes in the relationship diagram belong.

The first association relationship and the second association relationship may be any two different association relationships, including a recommendation relationship, reference relationship, matching relationship, and the like. For example, the first association relationship and the second association relationship may be the recommendation relationship and reference relationship. In this case, the first relationship is the reference relationship, and the second relationship is the recommendation relationship; or, the first relationship is the recommendation relationship, and the second relationship is the reference relationship. The reference relationship includes at least one of a forward reference relationship and a reverse reference relationship. The forward reference relationship may be understood as the first document referencing another document. Existence of the forward reference relationship between the first document and a certain document may be determined in a case that the certain document is referenced in the first document. The reverse reference relationship may be understood as the first document being referenced in another document, that is, the first document is referenced by other documents. Existence of the reverse reference relationship between the first document and a certain document may be determined in a case that the certain document references the first document.

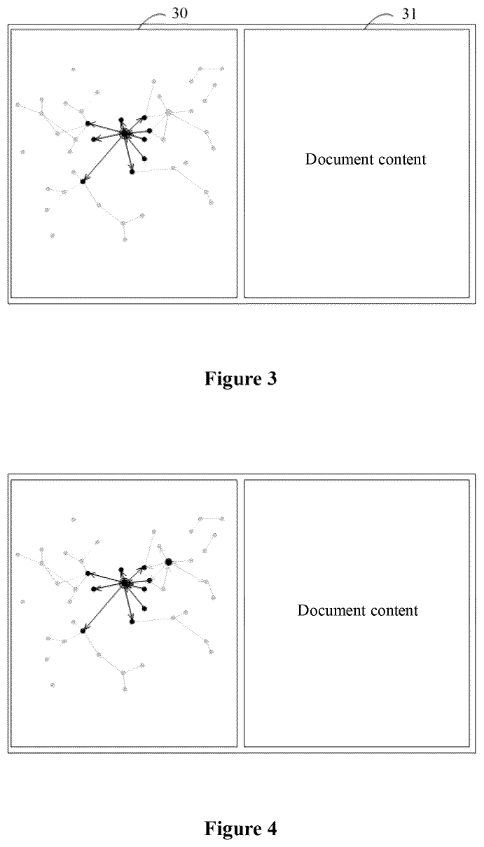

In an implementation, after determining the first document displayed on the target page, the electronic device may further determine the second document that has the first association relationship or the second association relationship with the first document, display the relationship diagram for the first document and the second document in a first area 30 of the target page, and display content of the first document in a second area 31 of the target page, as shown in the FIG. 3.

In an embodiment, after determining the first document displayed on the target page, the electronic device may create a new area (namely, the first area) on the target page, and display, in the first area, the relationship diagram for the first document and the second document. In this case, a process of displaying the relationship diagram for the first document and the second document in the first area of the target page, and displaying the content of the first document in the second area of the target page includes: creating a first area within the target page, displaying, in the first area, the relationship diagram for the first document and the second document, and adjusting, based on a display range of the first area, a display range of the second area where the first document is located within the target page.

In an example, the electronic device may create the first area based on a preset shape and/or size, and adjust the display range of the second area (i.e., area for displaying document content) based on the display range of the first area. For example, the display range of the second area is reduced based on the display range of the first area, so that both the second area and the first area are displayed within the page, that is, both the relationship diagram for the first document and the second document and the content of the first document are displayed on the page. Thereby, the user, while viewing the content of the first document, can view the association relationship between the first document and another document, or instruct the electronic device to search for a document corresponding to a node in the relationship diagram by clinking on the node.

In an embodiment, the display range of the first area and the display range of the second area may be the same as or different from each other. The display ranges may be the same so that the user can clearly view the relationship diagram and the document content. In this case, a process of adjusting, based on the display range of the first area, the display range of the second area where the first document is located within the target page includes: displaying both the first area and the second area in a display-allowed area of the page, where the display range of the first area is the same as the display range of the second area. The display-allowed area of the page may be an area where the entire page is located, or may be an area other than a border, a function bar, and other areas in the page.

In an embodiment, the first document is in a first association relationship with the second document. A process of displaying, in the first area of the target page, the relationship diagram for the first document and the second document includes: displaying, in the relationship diagram, a node of the first document in a first display state, a node of the second document in a second display state, and a node other than the node of the first document or the node of the second document in a third display state.

The first display state, second display state, and third display state may be different from each other, not all the same, or the same. A case of three different display states is taken as an example and described here. Nodes having different display states may be distinguished from each other by different shapes and/or colors. For example, the first display state may be highlighted (in blue, for example) in a form of a non-dot (such as a dot having a circle around), the second display state may be highlighted in a form of a dot, and the third display state may be non-highlighted (in gray, for example) in a form of a dot.

In the above implementation, in a case that the first document is in the first association relationship with the second document, different display states can be adopted to display a node of the first document, a node of the second document, and nodes in the relationship diagram other than the node of the first document and the node of the second document. This facilitates the user to distinguish between a node of the document viewed by the user (i.e., the first document) and a node of a document in the first association relationship or the second association relationship with the document viewed by the user.

A case that the first association relationship is a reference relationship is taken as an example. On receiving of the document relationship query operation, the electronic device may display content of the first document in the second area, and display the relationship diagram in the first area. In the relationship diagram, the node of the first document is displayed in the first display state, the node of the second document in the reference relationship with the first document is displayed in the second display state, and a node other than the node of the first document or the node of the second document is displayed in the third display state.

In another embodiment, the first document is in the second association with the second document, and a process of displaying, in a first area of the target page, a relationship diagram for the first document and a second document includes: displaying, in the relationship diagram, a node of the first document in a first display state, a node of a fourth document in a second display state, and a node other than the node of the first document or the node of the fourth document in a third display state. The first document is in the first association relationship with the fourth document, and the node other than the node of the first document or the node of the fourth document includes a node of the second document.

In a case that the first document is in the second association relationship with the second document, that is, the second document is a document that has the second association relationship with the first document, the fourth document may be in the first association relationship with the first document. The other nodes in the relationship diagram may refer to nodes other than the node of the first document and the node of the fourth document, and may further include a node of a document which is in the document space and is in neither the first association relationship nor the second association relationship with the first document.

In the above implementations, in the case that the first document is in the second association relationship with the second document, the node of the first document and the node of the second document may be displayed in different display states. Furthermore, the node of the fourth document in the first association relationship with the first document may be displayed in another display state. Thereby, the user can determine documents having different association relationships with the document being viewed.

The following description is made by taking an example in which the first association relationship is a reference relationship and the second association relationship is a recommendation relationship. The electronic device may display the content of the first document in the second area, display the relationship diagram in the first area, and display, in the relationship diagram, the node of the first document in the first display state, the node of the fourth document in the reference relationship with the first document in the second display state, and nodes of other documents (including the second document) other than the node of the first document and the node of the fourth document in the third display state.

In an embodiment, the manner for determining the second document that has the recommendation relationship with the first document may be selected as needed. For example, a recommendation degree of each document in the document space to which the first document belongs may be calculated based on a degree of association of document content (such as similarity), whether the document is browsed by a publisher of the first document, and whether the document is published by the publisher of the first document. The second document having the recommendation relationship with the first document may be determined based on this recommendation degree. For example, a document having a recommendation degree greater than a preset recommendation threshold is determined as the second document having the recommendation relationship with the first document. Additionally or alternatively, a preset number of documents are selected in an order of the recommendation degrees from highest to lowest as the second document having the recommendation relationship with the first document. The similarity between two documents may be determined through character matching and/or semantic matching. For example, the character matching and/or semantic matching may be performed between document titles, document abstracts, and/or document contents of the two documents to obtain the similarity between the two documents.

In the above implementation, the second document that has the recommendation relationship with the first document may or may not include a document that has the reference relationship with the first document. For example, the second document that has the recommendation relationship with the first document may be selected from documents other than the first document and the fourth document in the document space, or may be selected from documents (including the fourth document) other than the first document in the document space, which is not limited in the embodiments. In a case that the second document that has a recommendation relationship with the first document includes a document that has a reference relationship with the first document, the document that has a reference relationship with the first document may be displayed in the second display state, and a document that does not have a reference relationship with the first document may be displayed in the third display state.

In an implementation, a process of displaying, in a first area of the target page, a relationship diagram for the first document and a second document further includes: displaying a first association path connecting the node of the first document and the node of the second document in a first connection state, where the first connection state includes path direction information of the first association path, and the first connection state has a first path display state.

The first relationship path may be understood as a relationship path connecting the node of the first document and the node of the second document. The first connection state may be understood as a connection state having a first path display state. The first path display state may be a state of being highlighted in a certain color (such as blue). The path direction information of the first relationship path may be identified by an arrow.

In an embodiment, when the relationship diagram for the first document and the second document is displayed, an association direction of the association relationship between the first document and the second document may be further identified by a path direction of the first relationship path connecting the node of the first document and the node of the second document. For example, in a case that the first document is in the recommendation relationship with the second document, the path direction of the first association path may be directed from the first document to the second document (or from the second document to the first document), to indicate that the second document is in the recommendation relationship with the first document, that is, the second document is a recommended document of the first document determined based on the first document. In a case that the first document is in the reference relationship with the second documents, the path direction of the first association path may be directed from a referencing document to a referenced document (or from the referenced document to the referencing document). For example, in a case that the second document is referenced in the first document, the association path connecting the first document and the second document may be directed from the first document to the second document (or from the second document to the first document). In a case that the second document references the first document, the association path connecting the first document and the second document may be directed from the second document to the first document (or from the first document to the second document). A node of the document having a forward reference relationship with the first document and a node of the document having a reverse reference relationship with the first document are identified, so that the user can easily distinguish the documents.

In an embodiment, after the displaying, in a first area of the target page, a relationship diagram for the first document and a second document, the method further includes: in response to a focus moving to a node of any second document other than the node of the first document, displaying the node of the second document in the second display state, and displaying a second association path connecting the node of the second document and a node of a fifth document in a second connection state, where the second document is in the first association relationship or the second association relationship with the fifth document, the second connection state includes path direction information of the second association path, and the second connection state has a second path display state.

The second document may be understood as a document corresponding to a node to which a cursor is moved, and the fifth document may be a document having a first association relationship or second association relationship with the second document. The second association path may be understood as an association path connecting the second document and the fifth document. The second connection state may be a state of displaying the association path in the second path display state. The second path display state may be the same as or different from the first path display state. For the case that the second path display state is different from the first path display state, for example, the first path display state is a highlighted state including path direction information, and the second path display state may be a non-highlighted display state including the path direction information.

In the above implementation, the user can control a focus (such as the cursor) to move to a position of a node of a certain document (i.e., the second document) in the relationship diagram, so as to view the fifth document associated with the document and the association direction between the second document and the fifth document.

In an example, the electronic device displays in the relationship diagram the association relationship between the first document and the second document; the user controls the focus to move to the display position of the node of the second document, in a case that the user wants to view the association relationship and/or direction between the second document and other documents; the electronic device, on detecting that the focus is moved to the display position of the node of the second document, displays the node of the second document in the second display state in a case that the node of the second document is not the node of the first document in the first display state, and display the association direction between the second document and the fifth document that has the association relationship with the second document. For example, the second association path between the second document and the fifth document is displayed in the second path display state.

For example, on detecting that the focus is moved to the node of the first document, the electronic device may keep displaying the node of the first document in the first display state, display the node of the document having the first association with the first document in the second display state, and display a node other than the node of the first document and the node of the second document in the third display state, and display the association path connecting the node of the first document and the node of the document having the first association relationship with the first document in the first display state; on detecting that the focus is moved to a node in the second display state, the electronic device may keep displaying the node in the second display state, display the association path between the node and the node of the first document in the first path display state, and display the association path connecting the node and another node of a document having the first association relation or the second association relationship with the document to which the node belongs in the second path display state; on detecting that the focus is moved to a node in the third display state, the electronic device may switch the display state of the node from the third display state to the second display state, and switch the association path connecting the node and another node of the document having the first association relationship or the second association relationship with the document to which the node belongs to the second path display state, as shown in FIG. 4.

It can be understood that the electronic device may display the node to which the focus is moved directly in the second display state, without considering whether the node is the node of the second document, and display the association path connecting the node and a node of the document having the first association relationship or the second association relationship with the document to which the node belongs in the second path display state.

With the method for querying a relationship of documents provided in the embodiments, a first document displayed on the target page is determined in response to the document relationship query operation performed by a user on the target page where content of the first document is displayed; the relationship diagram for the first document and the second document is displayed in the first area of the target page, where the first document is in the first association relationship or the second association relationship with the second document; and the content of the first document is displayed in the second area of the target page. With this technical solution, both content of a document and an association relationship between the document and other documents can be displayed. Therefore, the user is enabled to view a document associated with the first document pointedly based on the association relationship, and thereby user experience is improved.

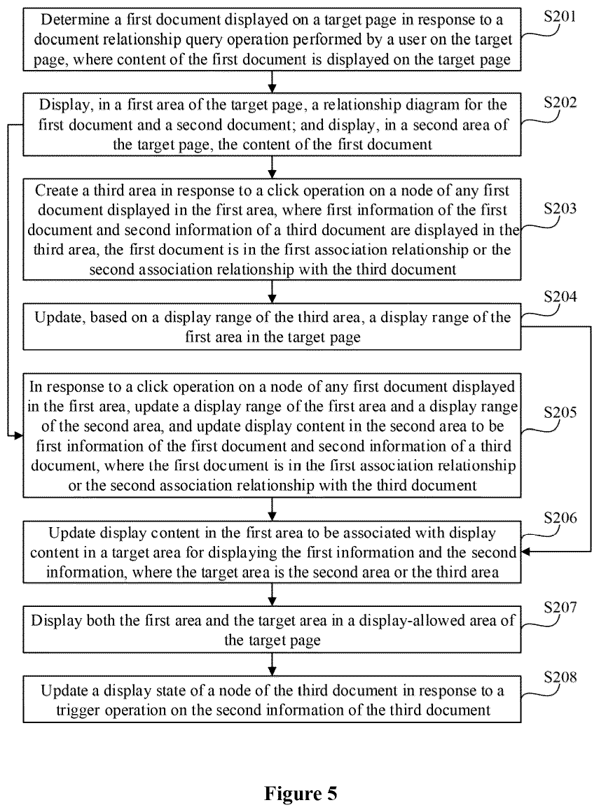

FIG. 5 is a flowchart of a method for querying a relationship of documents according to another embodiment of the present disclosure. The solution in this embodiment may be combined with solutions in one or more of the above embodiments. In an embodiment, the method further includes: creating a third area in response to a click operation on a node of any first document displayed in the first area, where first information of the first document and second information of a third document are displayed in the third area, and the first document is in the first association relationship or the second association relationship with the third document; and updating, based on a display range of the third area, a display range of the first area in the target page.

In an embodiment, the method further includes: in response to a click operation on a node of any first document displayed in the first area, updating a display range of the first area and a display range of the second area, and updating display content in the second area to be first information of the first document and second information of a third document, where the first document is in the first association relationship or the second association relationship with the third document.

In an embodiment, the method further includes: updating display content in the first area to be associated with display content in a target area for displaying the first information and the second information, where the target area is the second area or the third area.

In an embodiment, the method further includes: displaying both the first area and the target area in a display-allowed area of the target page.

In an embodiment, the method further includes: updating a display state of a node of the third document in response to a trigger operation on the second information of the third document.

Correspondingly, as shown in FIG. 5, the method for querying a relationship of documents provided in an embodiment includes the following steps S201 to S208.

In S201, a first document displayed on a target page is determined in response to a document relationship query operation performed by a user on the target page, where content of the first document is displayed on the target page.

In S202, a relationship diagram for the first document and a second document is displayed in a first area of the target page, and the content of the first document is displayed in a second area of the target page. The method proceeds to S203 or S205. The first document is in a first association relationship or a second association relationship with the second document.

In S203, a third area is created in response to a click operation on a node of any first document displayed in the first area, where first information of the first document and second information of a third document are displayed in the third area, and the first document is in the first association relationship or the second association relationship with the third document.

The first information may be understood as document information of the first document, and the second information may be document information of the third document. The first information and the second information may include the same or different content. For example, the first information and the second information may both include at least one of a name, a cover, or an introduction (such as an abstract, content summary or part or the entire document content) of a corresponding document. Alternatively, the first information may include at least one of a name, an introduction, a cover, or the like, of the first document; and the second information may include at least one of a name, a cover, or the like, of the third document, which is not limited in the embodiment.

In this embodiment, the user may instruct the electronic device, by clicking on a node of a document in the diagram, to display information of the document and information of another document having the first association relationship or the second association relationship with the document. Therefore, the electronic devices, on receiving the click operation on a node in the relationship diagram, may create a new area (i.e., the third area) and display the information of the aforementioned documents in the third area.

For example, in a case that the user wants to view information of a document to which a node in the relationship diagram belongs or wants to view information of a document that has the first association with or the second association with the document to which the node in the relationship diagram belongs, the user may click on that node in the relationship diagram. On detecting a click operation on a node in the relationship diagram, the electronic device may obtain the first information of the document to which the node belongs and the second information of the third document that has the first association relationship or the second association relationship with the node, create the third area, and display the obtained first information and the second information in the third area. In addition, the electronic device may further stop displaying the second area.

In S204, a display range of the first area in the target page is updated based on a display range of the third area. The method then proceeds to S206.

As an example, the third area may be created based on a pre-set shape and/or sire, and the display range of the first area may be further adjusted based on the display range of the third area. For example, the display range of the first area may be increased based on the display range of the third area, so that both the first area and the third area are displayed on the page, that is, the relationship diagram, the first information of the first document, and the second information of the third document are all displayed on the page. Thereby, the user can easily view the documents.

In S205, in response to a click operation on a node of any first document displayed in the first area, a display range of the first area and a display range of the second area are updated, and display content in the second area is updated to be first information of the first document and second information of a third document, where the first document is in the first association relationship or the second association relationship with the third document.

In an embodiment, on receiving a click operation on a node displayed in the relationship diagram, the electronic device may directly display, in the second area, the node and information of a document having the first association relationship or the second association relationship with the document to which the node belongs.

In an implementation, the electronic device, on detecting that the user clicks on a node (i.e., a first target node) in the relationship diagram, may obtain the first information of the document to which the first target node belongs and the second information of the third document that has the first association relationship or second association relationship with the first target document, update the display range of the first area and the display range of the second area, and display the first information of the first document and the second information of the third document in the second area.

In S206, display content in the first area is updated to be associated with display content in a target area for displaying the first information and the second information, where the target area is the second area or the third area.

The target area may be understood as an area on the target page for displaying the first information of the first document and the second information of the third document. For example, in a case that the first information of the first document and the second information of the third document are displayed in the created third area, the target area may be the third area. In a case that the first information of the first document and the second information of the third document are displayed in the second area, the target area may be the second area.

In an embodiment, in response to the user clicking on a node of the first document in the relationship diagram, the electronic device may further update the display content of the first area. For example, a size of the relationship diagram displayed in the first area, the number of nodes displayed in the first area, and/or the display state of a corresponding node in the first area are updated in order to associate the display content of the first area with the displayed first information and the second information. Thereby, the user can easily view the documents.

For example, to update the display content of the first area, the electronic device may adjust the size of the relationship diagram to completely display the diagram in the first area, or to display only partial content of the relationship diagram in the first area, including the node of the first document and/or a node of a document corresponding to the display content in the target area. The electronic device may further display the node of the first document in the first display state, the fourth display state, or any other display state, and display the document having the first/second association relationship with the first document in the second display state or the third display state.

In S207, the first area and the target area are both displayed in a display-allowed area of the target page.

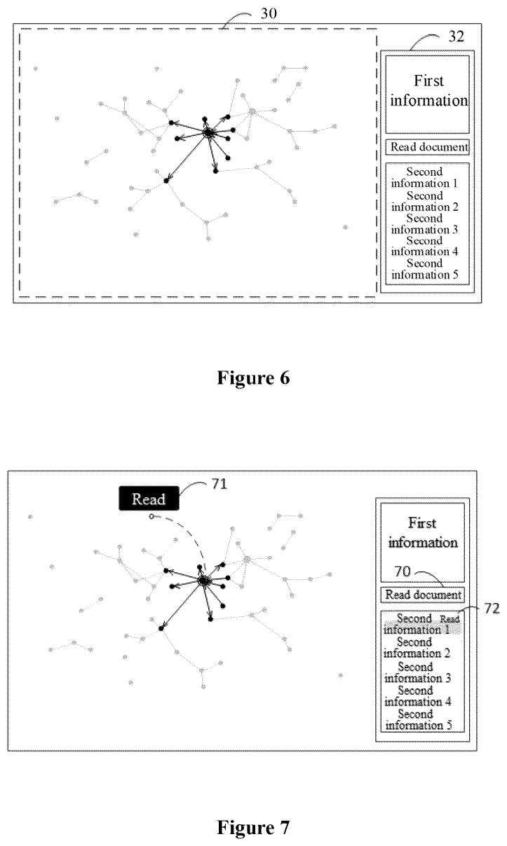

In this embodiment, as shown in FIG. 6 (taking the first document as an example), the first area 30 and the target area 32 are both displayed on the target page, that is, the relationship diagram including the association relationship between the first document and the third document, the first information of the first document, and the second information of the third document are all displayed on the target page, to be viewed by the user.

In S208, a display state of a node of the third document is updated in response to a trigger operation on the second information of the third document.

The trigger operation may be understood as an operation of triggering the second information of a certain third document displayed in the target area, such as moving the focus to the second information or clicking on the second information.

In an implementation, in a case that the user wants to view the association relationship between the third document and another document, the user may trigger the second information of the third document by executing a corresponding trigger operation. On detecting the triggering action by the user on the second information of the third document, the electronic device may switch the node of the third document to a corresponding display state. For example, the third document is displayed in a display state different from the first display state, second display state, or third display state. For example, the node clicked by the user is displayed in a color (such as yellow) different from the color of a node in the first display state, the second display state, or the third display state and/or is displayed in a shape (such as circle) different from the shape of a node in the first display state, the second display state, or the third display state. The electronic device may further display a relationship path between the first document and the third document in a preset path display manner, such as by a dashed line without path direction information. Thereby, the user can distinguish the second document triggered by the user, as shown in FIG. 7 (an example in which the user triggers a first entry of the second information).

In addition, on detecting that a user clicks on the second information of the third document, the electronic device may further display a reading control for the third document. The user may view the third document by triggering the reading control for the third document. In this case, the method for querying a relationship of documents according to an embodiment may further include: displaying, in response to the trigger operation, a first reading control for a corresponding third document in the relationship diagram; and/or displaying, in response to the trigger operation, a second reading control corresponding to the third document in the target area.

Reference is made to FIG. 7. As an example, the electronic device displays a reading control 70 for the first document in the target area. On receiving a trigger operation on the second information of the third document, the electronic device displays a first reading control 71 for the third document in the first area and/or a second reading control 72 for the third document in the target area. Therefore, the user may click on the reading control 70 for the first document when wants to view the content of the first document, and/or click on the first reading control 71 or the second reading control 72 when wants to view the content of the third document. On detecting that the user clicks on the reading control 70 for the first document, the electronic device displays the second area 31 on the page, and displays the content of the first document in the second area 31. On detecting that the user clicks on the first reading control 71 or the second reading control 72 for the third document, the electronic device displays the second area 31 on the page, and displays the content of the third document in the second area 31, as shown in FIG. 3.

In the method for querying a relationship of documents provided in this embodiment, in response to a node in the relationship diagram being clicked by the user, the association relationship between the first document corresponding to the node and the third document having the association relationship with the first document is displayed, and the first document of the first document and the second information of the third document are displayed. The content displayed in the relationship diagram is updated synchronously while the user performing the trigger operation on the first information of the first document or the second information of the third document. Thereby, the user is not only provided with convenience to view information of the documents, but also enabled to view the association relationships of the documents synchronously while viewing the information of the documents. Therefore, user experience is improved.

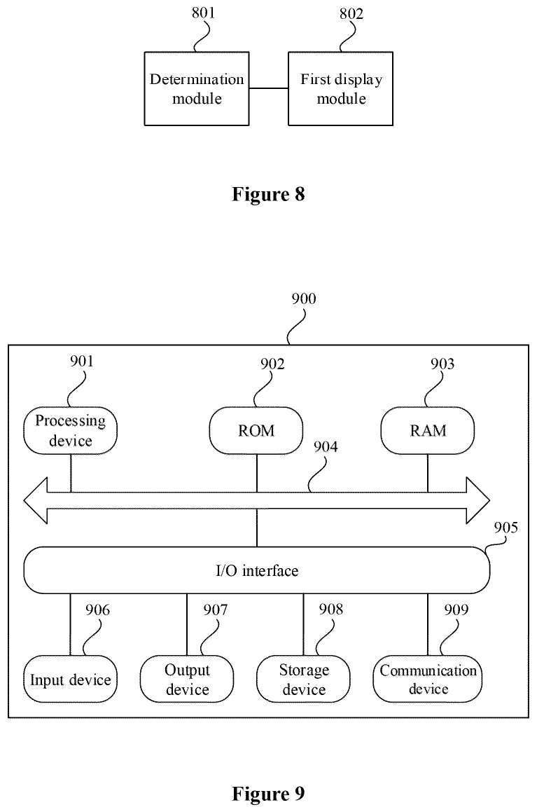

FIG. 8 is a structural block diagram of an apparatus for querying a relationship of documents according to an embodiment of the present disclosure. The apparatus may be implemented by software and/or hardware, and may be configured in an electronic device. Typically, the apparatus may be configured in a computer device, and is able to query an association relationship of documents by executing the method for querying a relationship of documents. As shown in FIG. 8, the apparatus for querying a relationship of documents in an embodiment may include a determination module 801 and a first display module 802.

The determination module 801 is configured to determine a first document displayed on a target page in response to a document relationship query operation performed by a user on the target page, where content of the first document is displayed on the target page.

The first display module 802 is configured to: display, in a first area of the target page, a relationship diagram for the first document and a second document; and display, in a second area of the target page, the content of the first document, where the first document is in a first association relationship or a second association relationship with the second document.

In the apparatus for querying a relationship of documents provided in the embodiment, the first document displayed on the target page is determined through the determination unit in response to a document relationship query operation on the target page by the user, where the content of the first document is displayed on the target page; the first document and the relationship diagram for the first document and the second document are displayed in the first area of the target page through the first display module, where the first document is in a first association relationship or a second association relationship with the second document; and the content of the first document is displayed in the second area of the target page through the first display module. With this technical solution, both content of a document and an association relationship between the document and other documents can be displayed. Therefore, the user is enabled to view a document associated with the first document pointedly based on the association relationship, and thereby user experience is improved.

In a further embodiment, the apparatus for querying a relationship of documents may further include an area creation module and a range update module. The area creation module is configured to: create a third area in response to a click operation on a node of any first document displayed in the first area, where first information of the first document and second information of a third document are displayed in the third area, and the first document is in the first association relationship or the second association relationship with the third document. The range update module is configured to update, based on a display range of the third area, a display range of the first area in the target page.

In a further embodiment, the apparatus for querying a relationship of documents may further include an area update module. The area update module is configured to in response to a click operation on a node of any first document displayed in the first area, update a display range of the first area and a display range of the second area, and update display content in the second area to be first information of the first document and second information of a third document, where the first document is in the first association relationship or the second association relationship with the third document.

In a further embodiment, the apparatus for querying a relationship of documents may further include a content update module. The content update module is configured to update display content in the first area to be associated with display content in a target area for displaying the first information and the second information, where the target area is the second area or the third area.

In a further embodiment, the apparatus for querying a relationship of documents may further include a second display module. The second display module is configured to display both the first area and the target area in a display-allowed area of the target page.

In a further embodiment, the apparatus for querying a relationship of documents may further include a state update module. The state update module is configured to update a display state of a node of the third document in response to a trigger operation on the second information of the third document.

In an embodiment, the first document may be in the first association relationship with the second document, and the first display module 802 may be configured to: display, in the relationship diagram, a node of the first document in a first display state, a node of the second document in a second display state, and a node other than the node of the first document or the node of the second document in a third display state.

In an embodiment, the first document may be in the second association relationship with the second document, and the first display module 802 may be configured to: displaying, in the relationship diagram, a node of the first document in a first display state, a node of a fourth document in a second display state, and a node other than the node of the first document or the node of the fourth document in a third display state, where the first document is in the first association relationship with the fourth document, and the node other than the node of the first document or the node of the fourth document includes a node of the second document.

In the above scheme, the first display module 802 may be further configured to: display a first association path connecting the node of the first document and the node of the second document in a first connection state, where the first connection state includes path direction information of the first association path, and the first connection state has a first path display state.

In a further embodiment, the apparatus for querying a relationship of documents may further include a response module. The response module is configured to: after the relationship diagram for the first document and a second document is displayed in the first area of the target page, and in response to a focus moving to a node of any second document other than the node of the first document, display the node of the second document in the second display state, and display a second association path connecting the node of the second document and a node of a fifth document in a second connection state, where the second document is in the first association relationship or the second association relationship with the fifth document, the second connection state includes path direction information of the second association path, and the second connection state has a second path display state.

In an embodiment, the first association relationship may be a reference relationship, and the second association relationship may be a recommendation relationship; the first association may be a recommendation relationship, and the second association may be a reference relationship; where the reference relationship includes at least one of a forward reference relationship and a reverse reference relationship.

In an embodiment, the first display module 802 may be configured to: create the first area within the target page, display, in the first area, the relationship diagram for the first document and the second document, and adjust, based on a display range of the first area, a display range of the second area where the first document is located within the target page.

The apparatus for querying a relationship of documents provided in the embodiments of the present disclosure can execute the method for querying a relationship of documents provided in any of the embodiments of the present disclosure, and has functional modules and beneficial effects corresponding to execution of the method for querying a relationship of documents. Technical details not fully described in these embodiments may be found in the method for querying a relationship of documents provided in any of the embodiments of the present disclosure.

Reference is made to FIG. 9, which shows a schematic structural diagram of an electronic device 900 (for example, a terminal device) suitable for implementing the embodiments of the present disclosure. The terminal device in the embodiments of the present disclosure may include but not limited to mobile terminals such as a mobile phone, a notebook computer, a digital broadcast receiver, a personal digital assistance (PDA), a tablet computer (PAD), a portable multi-media player (PMP) and a vehicle terminal (such as a vehicle navigation terminal); and fixed terminals such as a digital TV and a desktop computer. The electronic device shown in FIG. 9 is merely an example, and is not intended to limit functions and scope of the embodiments of the present disclosure.

As shown in FIG. 9, the electronic device may include a processing apparatus (such as a central processor and a graphic processor) 901. The processing apparatus may perform various appropriate actions and processing based on programs stored in a read-only memory (ROM) 902 or programs loaded from a storage device 906 to a random access memory (RAM) 903. Various programs and data required for operations of the electronic device 900 are stored in the RAM 903. The processing apparatus 901, the ROM 902 and the RAM 903 are connected to each other through a bus 904. An input/output (I/O) interface 905 is connected to the bus 904.

Generally, the following components are connected to the I/O interface 905: an input device 906 such as a touch screen, a touch panel, a keyboard, a mouse, a camera, a microphone, an accelerometer, and gyroscope; an output device 907 such as a liquid crystal display (LCD), a loudspeaker and a vibrator; a storage device 906 such as a magnetic tape and a hard disk; and a communication device 909. The communication device 909 may allow the electronic device 900 to communicate with other devices in a wired or wireless manner to exchange data. Although FIG. 9 shows the electronic device 900 provided with various apparatuses, it should be understood that not all shown apparatuses are necessary. Alternatively, more or less apparatuses may be implemented or included.

According to the embodiments of the present disclosure, a process described in the flowchart may be implemented by computer software programs. For example, according to an embodiment of the present disclosure, a computer program product including computer program carried on a non-transitory computer readable medium is provided. The computer program includes program codes for performing the method shown in the flowchart. In such embodiment, the computer program may be downloaded and installed from the network through the communication apparatus 909, installed from the storage apparatus 906 or installed from the ROM 902. The computer program, when executed by the processing apparatus 901, performs functions defined in the methods described in the embodiments of the present disclosure.

It should be noted that, the computer-readable medium described in the present disclosure may be a computer readable signal medium, a computer readable storage medium or any combination thereof. The computer readable storage medium may include but not limited to a system, an apparatus or a device in an electric, magnetic, optical, electromagnetic, infrared or a semiconductor form, or any combination thereof. The computer readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof. In the present disclosure, the computer readable storage medium may be a tangible medium including or storing programs. The programs may be used by or in combination with an instruction execution system, apparatus or device. In the present disclosure, a computer readable signal medium may include a data signal in a baseband or propagated as a part of carrier. The computer readable signal medium carries computer readable program codes. The propagated data signal may include but not limited to an electromagnetic signal, an optical signal or any combination thereof. The computer readable signal medium may be any computer readable medium other than the computer readable storage medium. The computer readable signal medium may send, propagate or transmit programs used by or in combination with the instruction execution system, apparatus or device. The program code included in the computer readable medium may be transmitted via any appropriate medium, including but not limited to an electric wire, an optical fiber, radio frequency (RF) or any appropriate combination thereof.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (for example ad hoc peer-to-peer network), and any known network or network to be developed.

The computer readable medium may be included in the electronic device described above, or may exist independently and is not installed in the electronic device.

The computer readable storage medium carries one or more programs. The one or more programs, when being executed by the electronic device, causes the electronic device to: determine a first document displayed on a target page in response to a document relationship query operation performed by a user on the target page, where content of the first document is displayed on the target page; display, in a first area of the target page, a relationship diagram for the first document and a second document, and display, in a second area of the target page, the content of the first document, where the first document is in a first association relationship or a second association relationship with the second document.

Computer program codes for performing operations of the present disclosure may be written by using one or more program design language or any combination. The program design language includes but not limited to object-oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowcharts and block diagrams shown in the drawings show a system architecture, function and operation which may be implemented by the system, method and computer program product according to the embodiments of the present disclosure. Each block in the flowcharts or the block diagram may represent a part of a module, a program section or codes including executable instructions for implementing specified logic functions. It should be noted that, in an alternative embodiment, functions denoted in the blocks may be performed in an order different from the order denoted in the drawing. For example, operations in two blocks connected successively may be performed in parallel, or may be performed in an opposite order, depending on the involved function. It should be noted that, each block in the block diagrams and/or flowcharts, and a combination of blocks in the block diagrams and/or flowcharts may be implemented by a dedicated hardware system for performing specified functions or operations, or may be implemented by a combination of dedicated hardware and computer instructions.

Units involved in the embodiments of the present disclosure may be implemented by software or hardware. Names of the module do not limit the module in a certain case.

The functions described above herein may be performed at least partially by one or more hardware logical components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD) and the like.

In the context of the present disclosure, the computer readable medium may be a tangible medium including or storing programs. The programs may be used by an instruction execution system, apparatus or device, or may be used in combination with the instruction execution system, apparatus or device. The machine-readable medium may be a machine-readable signal medium or a machine-readable storage medium. The machine-readable medium may include but not limited to a system, an apparatus or a device in an electric, magnetic, optical, electromagnetic, infrared, or a semiconductor form, or any combination thereof. The machine-readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof.

According to one or more embodiments of the present disclosure, example 1 provides a method for querying a relationship of documents. The method includes:
determining a first document displayed on a target page in response to a document relationship query operation performed by a user on the target page, where content of the first document is displayed on the target page;
displaying, in a first area of the target page, a relationship diagram for the first document and a second document; and
displaying, in a second area of the target page, the content of the first document,
where the first document is in a first association relationship or a second association relationship with the second document.

According to one or more embodiments of the present disclosure, example 2 of the method according to example 1 further includes:
creating a third area in response to a click operation on a node of any first document displayed in the first area, where first information of the first document and second information of a third document are displayed in the third area, and the first document is in the first association relationship or the second association relationship with the third document; and
updating, based on a display range of the third area, a display range of the first area in the target page.

According to one or more embodiments of the present disclosure, example 3 of the method according to claim 1 further includes:
in response to a click operation on a node of any first document displayed in the first area,
   updating a display range of the first area and a display range of the second area, and
   updating display content in the second area to be first information of the first document and second information of a third document,
   where the first document is in the first association relationship or the second association relationship with the third document.

According to one or more embodiments of the present disclosure, example 4 of the method according to example 2 or 3 further includes:
updating display content in the first area to be associated with display content in a target area for displaying the first information and the second information, where
the target area is the second area or the third area.

According to one or more embodiments of the present disclosure, example 5 of the method according to example 4 further includes:
displaying both the first area and the target area in a display-allowed area of the target page.

According to one or more embodiments of the present disclosure, example 6 of the method according to example 2 or 3 further includes:
updating a display state of a node of the third document in response to a trigger operation on the second information of the third document.

According to one or more embodiments of the present disclosure, in example 7 of the method according to example 1:
the first document is in the first association relationship with the second document, and
the displaying, in a first area of the target page, a relationship diagram for the first document and a second document includes:
   displaying, in the relationship diagram, a node of the first document in a first display state, a node of the second document in a second display state, and a node other than the node of the first document or the node of the second document in a third display state.

According to one or more embodiments of the present disclosure, in example K of the method according to example 1:
the first document is in the second association relationship with the second document, and
the displaying, in a first area of the target page, a relationship diagram for the first document and a second document includes:
   displaying, in the relationship diagram, a node of the first document in a first display state, a node of a fourth document in a second display state, and a node other than the node of the first document or the node of the fourth document in a third display state, where
   the first document is in the first association relationship with the fourth document, and the node other than the node of the first document or the node of the fourth document includes a node of the second document.

According to one or more embodiments of the present disclosure, in example 9 of the method according to example 7 or 8:
the displaying, in a first area of the target page, a relationship diagram for the first document and a second document further includes:
   displaying a first association path connecting the node of the first document and the node of the second document in a first connection state, where the first connection state includes path direction information of the first association path, and the first connection state has a first path display state.

According to one or more embodiments of the present disclosure, example 10 of the method according to example 7 or 8 further includes:
after the displaying, in a first area of the target page, a relationship diagram for the first document and a second document, and in response to a focus moving to a node of any second document other than the node of the first document,
displaying the node of the second document in the second display state, and
displaying a second association path connecting the node of the second document and a node of a fifth document in a second connection state, where
the second document is in the first association relationship or the second association relationship with the fifth document,
the second connection state includes path direction information of the second association path, and
the second connection state has a second path display state.

According to one or more embodiments of the present disclosure, in example 11 of the method according to example 1 to 3 or example 7 to 8:
the first association relationship is a reference relationship, and the second association relationship is a recommendation relationship; or
the first association is a recommendation relationship, and the second association is a reference relationship; where
the reference relationship includes at least one of a forward reference relationship and a reverse reference relationship.

According to one or more embodiments of the present disclosure, in example 12 of the method according to example 1 to 3 or example 7 to 8:
the displaying, in a first area of the target page, a relationship diagram for the first document and a second document, and displaying, in a second area of the target page, the content of the first document includes:
   creating the first area within the target page
   displaying, in the first area, the relationship diagram for the first document and the second document, and
   adjusting, based on a display range of the first area, a display range of the second area where the first document is located within the target page.

According to one or more embodiments of the present disclosure, example 13 provides an apparatus for querying a relationship of documents. The apparatus includes:
a determination module, configured to determine a first document displayed on a target page in response to a document relationship query operation performed by a user on the target page, where content of the first document is displayed on the target page; and
a first display module, configured to display, in a first area of the target page, a relationship diagram for the first document and a second document, and display, in a second area of the target page, the content of the first document, where the first document is in a first association relationship or a second association relationship with the second document.

According to one or more embodiments of the present disclosure, example 14 provides an electronic device. The electronic device includes:
one or more processors;
a memory storing one or more programs, where
the one or more programs, when executed by the one or more processors, cause the one or more processors to perform the method for querying a relationship of documents according to any one of examples 1 to 12.

According to one or more embodiments of the present disclosure, example 15 provides a computer-readable storage medium storing a computer program. The computer program, when executed by a processor, implements the method for querying a relationship of documents according to any one of examples 1 to 12.

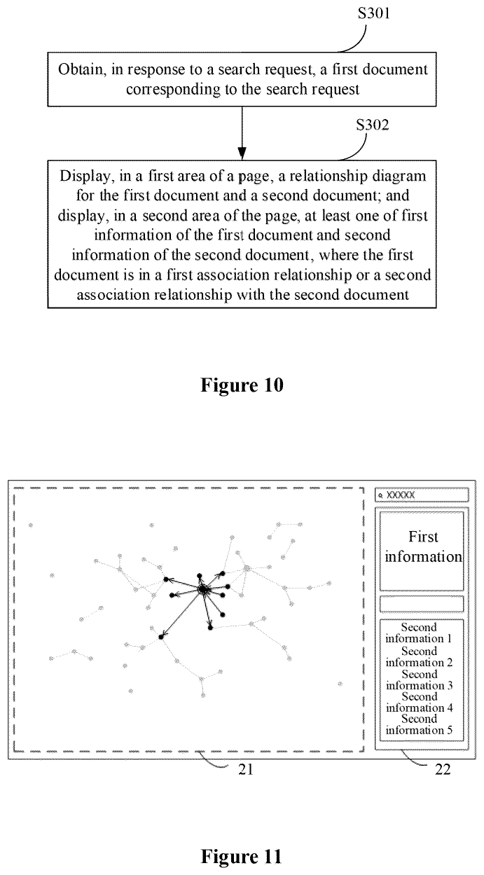

FIG. 10 is a schematic flowchart of a method for searching for a document according to an embodiment of the present disclosure. The method may be performed by an apparatus for searching for a document. The apparatus may be implemented by software and/or hardware, and may be integrated in an electronic device. Typically, the apparatus may be configured in a computer device. The method for searching for a document provided in the embodiments of the present disclosure is applicable to a scene of searching for a document. As shown in FIG. 10, the method provided in the present disclosure may include the following steps S301 to S302.

In S301, a first document corresponding to a search request is obtained in response to the search request.

The search request may be understood as a request for searching for a certain document. The search request may be generated based on a search operation from the user. The first document may be the document to be searched for as requested by the search request.

In an embodiment, in a case that the user requests to search for a certain document, for example, the user needs to search for the document to view document content and/or document information of the document, the user performs a trigger operation for searching for the document. The electronic device may generate the search request on detecting the trigger operation for searching for the document from the user, and performs searching in response to the search request to determine the document corresponding to the search request, that is, to determine the first document corresponding to the search request.

It may be understood that search request may be generated and sent by other devices. For example, the user may perform a search operation on another device having a communication connection with the electronic device. The search request for the document the user wants to search for is generated and sent through another device to the electronic device to instruct the electronic device to search for the document. On receiving the search request from another device, the electronic devices may search based on document identification information of the first document carried in the search request, such as a document name, a document ID, or a keyword, to determine the first document corresponding to the search request.

In S302, a relationship diagram for the first document and a second document is displayed in a first area of a page; and at least one of first information of the first document and second information of the second document is displayed in a second area of the page, where the first document is in a first association relationship or a second association relationship with the second document.

The second document may have the first association relationship or the second association relationship with the first document. The second document may be in a quantity of one or more. The relationship diagram for the first document and the second document may be understood as a graph characterizing an association relationship between the first document and the second document. The relationship diagram may display only the association relationship between the first document and the second document, or may further display an association relationship between the first document and another document. For example, the relationship diagram may be a document map of a document space to which the first document belongs. The document map may present an association relationship among all documents in the document space to which the first document belongs. Nodes for the documents in an association relationship may be connected by lines. The following description is made by taking this situation as an example. In addition, document names of the documents corresponding to the nodes may be further displayed in the relationship diagram for the first document and the second document, so that the user can distinguish the documents to which the nodes in the relationship diagram belong.

The first association relationship and the second association relationship may be any two different association relationships, including a recommendation relationship, reference relationship, matching relationship, and the like. For example, the first association relationship and the second association relationship may be the recommendation relationship and reference relationship. In this case, the first relationship is the reference relationship, and the second relationship is the recommendation relationship; or, the first relationship is the recommendation relationship, and the second relationship is the reference relationship. The reference relationship includes at least one of a forward reference relationship and a reverse reference relationship. The forward reference relationship may be understood as the first document referencing another document. Existence of the forward reference relationship between the first document and a certain document may be determined in a case that the certain document is referenced in the first document. The reverse reference relationship may be understood as the first document being referenced in another document, that is, the first document is referenced by other documents. Existence of the reverse reference relationship between the first document and a certain document may be determined in a case that the certain document references the first document.

The first area and the second area may be two display areas within the page. The first area may be for displaying the relationship diagram for the first document and the second document. The second area may be for displaying first information of the first document and/or second information of the second information. The second area may be displayed on a same layer as the first area, or may be located on a layer above the first area. The first information may be understood as document information of the first document, and the second information may be document information of the third document. The first information and the second information may include the same or different content. For example, the first information and the second information may both include at least one of a name, a cover, or an introduction (such as an abstract, content summary, or part of or the entire document content) of a corresponding document. The first information may include at least one of a name, an introduction, a cover, or the like, of the first document; and the second information may include at least one of a name, a cover, or the like, of the second document, which is not limited in the embodiment.

In an implementation, after the first document corresponding to the search request is obtained, the electronic device may further obtain the first information of the first document and the second information of the second document having the first association relationship or the second association relationship with the first document, display the relationship diagram for the first document and the second document in a first area 21 on a page, and display the first information of the first document and the second information of the second document in a second area 22 on the page, as shown in FIG. 11.

As an example, the electronic device displays a relationship diagram page of a document space and displays, on the page, the relationship diagram for documents within that document space. The user performs, on the page, a search operation for a document within the document space. On detecting the search operation for the document from the user, the electronic device generates a search request and obtains the document in response to the search request. The node of the first document and the node of the second document having the first association relationship or the second association relationship with the first document are displayed in corresponding display states in the relationship diagram, and a preview panel pops up. In the preview panel, the first information of the first document and a list of second documents are displayed. The second information of each second document is displayed in the list of second documents. In addition, the electronic device may further adjust a display position of the relationship diagram on the relationship diagram page so as to adjust the node of the first document to a center position on the relationship diagram page or a center position of the first area. Thereby, the user can view the association relationship between the first document and the second document.

In an embodiment, the first document is in a first association relationship with the second document. A process of displaying, in the first area of the page, the relationship diagram for the first document and the second document includes: displaying, in the relationship diagram, a node of the first document in a first display state, a node of the second document in a second display state, and a node other than the node of the first document or the node of the second document in a third display state.

The first display state, second display state, and third display state may be different from each other, not all the same, or the same. A preferred case of three different display states is taken as an example and described here. Nodes having different display states may be distinguished from each other by different shapes and/or colors. For example, the first display state may be highlighted (in blue, for example) in a form of a non-dot (such as a dot having a circle around), the second display state may be highlighted in a form of a dot, and the third display state may be non-highlighted (in gray, for example) in a form of a dot.

In the above implementation, in a case that the first document is in the first association relationship with the second document, different display states can be adopted to display a node of the first document, a node of the second document, and nodes in the relationship diagram other than the node of the first document and the node of the second document. This facilitates the user to distinguish between a node of the document searched for by the user (i.e., the first document) and a node of a document in the first association relationship or the second association relationship with the document searched for by the user.

The following description is made by taking an example in which the first association relationship is a reference relationship. Before the search request is received, that is, before the user performs the document search operation, the electronic device may display nodes of documents in the relationship diagram in the second display state. After the search request for the first document is received, the electronic device may: display, in the second area, the first information of the first document and the second information of each second document that has the reference relationship with the first document, switch the display state of the node of the first document in the relationship diagram from the second display state to the first display state, continue displaying the node of each second document that has the reference relationship with the first document in the second display state, and switch the display state of a node of another document in the relationship diagram other than the node of the first document or the node of the second document from the second display state to the third display state.

In another embodiment, the first document is in the second association with the second document, and a process of displaying, in a first area of the target page, a relationship diagram for the first document and a second document includes: displaying, in the relationship diagram, a node of the first document in a first display state, a node of a third document in a second display state, and a node other than the node of the first document or the node of the third document in a third display state. The first document is in the first association relationship with the third document, and the node other than the node of the first document or the node of the third document includes a node of the second document.

In a case that the first document is in the second association relationship with the second document, that is, the second document is a document that has the second association relationship with the first document, the third document may be in the first association relationship with the first document. The other nodes in the relationship diagram may refer to nodes other than the node of the first document and the node of the third document, and may include a node of a second document in the second association relationship with the first document and may further include a node of a document which is in the document space and is in neither the first association relationship nor the second association relationship with the first document.

In the above implementations, in the case that the first document is in the second association relationship with the second document, the node of the first document and the node of the second document may be displayed in different display states. Furthermore, the node of the third document in the first association relationship with the first document may be displayed in another display state. Thereby, the user can determine documents having different association relationships with the document being searched for.

The following description is made by taking an example in which the first association relationship is a reference relationship and the second association relationship is a recommendation relationship. Before the search request is received, that is, before the user performs the document search operation, the electronic device may display nodes of documents in the relationship diagram in the second display state. After the search request for the first document is received, the electronic device may: display, in the second area, the first information of the first document and the second information of each second document that has the recommendation relationship with the first document, switch the display state of the node of the first document in the relationship diagram from the second display state to the first display state, continue displaying the node of the third document that has the reference relationship with the first document in the second display state, and switch the display state of a node of another document (including the second document) in the relationship diagram other than the node of the first document or the node of the third document from the second display state to the third display state.

In an embodiment, a manner for determining the second document that has the recommendation relationship with the first document may be selected as needed. For example, a recommendation degree of each document in the document space to which the first document belongs may be calculated based on a degree of association of document content (such as similarity), whether the document is browsed by a publisher of the first document, and whether the document is published by the publisher of the first document. The second document having the recommendation relationship with the first document may be determined based on this recommendation degree. For example, a document having a recommendation degree greater than a preset recommendation threshold is determined as the second document having the recommendation relationship with the first document. Additionally or alternatively, a preset number of documents are selected in an order of the recommendation degrees from highest to lowest as the second document having the recommendation relationship with the first document. The similarity between two documents may be determined through character matching and/or semantic matching. For example, the character matching and/or semantic matching may be performed between document titles, document abstracts, and/or document contents of the two documents to obtain the similarity between the two documents.

In the above implementation, the second document that has the recommendation relationship with the first document may or may not include a document that has the reference relationship with the first document. For example, the second document that has the recommendation relationship with the first document may be selected from documents other than the first document and the third document in the document space, or may be selected from documents (including the third document) other than the first document in the document space, which is not limited in the embodiments. In a case that the second document that has a recommendation relationship with the first document includes a document that has a reference relationship with the first document, the document that has a reference relationship with the first document may be displayed in the second display state, and a document that does not have a reference relationship with the first document may be displayed in the third display state.

In an implementation, a process of displaying, in a first area of the page, a relationship diagram for the first document and a second document further includes: displaying a first association path connecting the node of the first document and the node of the second document in a first connection state, where the first connection state includes path direction information of the first association path, and the first connection state has a first path display state.

The first relationship path may be understood as a relationship path connecting the node of the first document and the node of the second document. The first connection state may be understood as a connection state having a first path display state. The first path display state may be a state of being highlighted in a certain color (such as blue). The path direction information of the first relationship path may be identified by an arrow.

In an embodiment, when the relationship diagram for the first document and the second document is displayed, an association direction of the association relationship between the first document and the second document may be further identified by a path direction of the first relationship path connecting the node of the first document and the node of the second document. For example, in a case that the first document is in the recommendation relationship with the second document, the path direction of the first association path may be directed from the first document to the second document (or from the second document to the first document), to indicate that the second document is in the recommendation relationship with the first document, that is, the second document is a recommended document of the first document determined based on the first document. In a case that the first document is in the reference relationship with the second documents, the path direction of the first association path may be directed from a referencing document to a referenced document (or from the referenced document to the referencing document). For example, in a case that the second document is referenced in the first document, the association path connecting the first document and the second document may be directed from the first document to the second document (or from the second document to the first document). In a case that the second document references the first document, the association path connecting the first document and the second document may be directed from the second document to the first document (or from the first document to the second document). A node of the document having a forward reference relationship with the first document and a node of the document having a reverse reference relationship with the first document are identified, so that the user can easily distinguish the documents.

The following description is made by taking an example in which the first association relationship is a reference relationship and the second association relationship is a recommendation relationship. Before the search request is received, that is, before the user performs the document search operation, the electronic device may display, in the relationship diagram, relationship paths among nodes of documents having the reference relationship with each other in another path display state, such as a non-highlighted (in gray, for example) state without path direction information. After the search request for the first document is received, the electronic device may switch a display state of a first relationship path between the first document and the second document to the first path display state.

In an embodiment, after displaying, in the first area of the page, the relationship diagram for the first document and the second document, the method further includes: in response to a focus moving to a node of a target document other than the node of the first document, displaying the node of the target document in the second path display state, and display a second association path connecting the node of the target document and a node of a fourth document in a second connection state, where the target document is in the first association relationship or the second association relationship with the fourth document, the second connection state includes path direction information of the second association path, and the second connection state has the second path display state.

The target document may be understood as a document corresponding to the node to which the cursor is moved. The fourth document may be a document having the first association relationship or the second association relationship with the target document. The second association path may be understood as an association path connecting the target document and each fourth document. The second connection state may be a state of displaying the association path in the second path display state. The second path display state may be the same as or different from the first path display state, preferably may be the different from the first path display state. For example, the first path display state is a highlighted state including path direction information, and the second path display state may be a non-highlighted display state including the path direction information.

In the above implementation, the user may control the focus (such as a cursor) to move to a position of a node of a certain document in the relationship diagram, so as to view the fourth document associated with the document (i.e., the target document) and an association direction between the target document and the fourth document.

In an implementation, the electronic device displays the association relationship between the first document and the second document in the relationship diagram. The user, when wants to view the association relationship and/or association direction between a certain document (i.e., the target document) and other documents, may control the focus to move to the display position of the node of the target document. On detecting that the focus is moved to the display position of the node of the target document, the electronic device may display the node of the target document in the second display state, in a case that the node of the target document is not the node of the first document in the first display state, and display the association direction between the target document and the fourth document that has an association relationship with the target document. For example, the second association path between the target document and each fourth document is displayed in the second path display state.

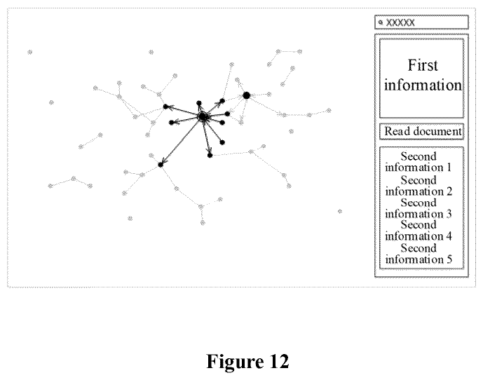

For example, on detecting that the focus is moved to the node of the first document, the electronic device may keep displaying the node of the first document in the first display state, display the node of the document having the first association with the first document in the second display state, and display a node other than the node of the first document and the node of the second document in the third display state, and display the association path connecting the node of the first document and the node of the document having the first association relationship with the first document in the first path display state; on detecting that the focus is moved to a node in the second display state, the electronic device may keep displaying the node in the second display state, display the association path between the node and the node of the first document in the first path display state, and display the association path connecting the node and another node of a document having the first association relation or the second association relationship with the document to which the node belongs in the second path display state; on detecting that the focus is moved to a node in the third display state, the electronic device may switch the display state of the node from the third display state to the second display state, and switch the association path connecting the node and another node of the document having the first association relationship or the second association relationship with the document to which the node belongs to the second path display state, as shown in FIG. 12.

It can be understood that the electronic device may display the node to which the focus is moved directly in the second display state, without considering whether the node is a node of the second document, and display the association path connecting the node and a node of the document having the first association relationship or the second association relationship with the document to which the node belongs in the second path display state.

With the method and the apparatus for searching for a document according to the embodiments of the present disclosure, the first document corresponding to the search request is obtained in response to the search request; a relationship diagram for the first document and a second document is displayed in the first area of the page, where the first document is in a first association relationship or a second association relationship with the second document; and first information of the first document and second information of the second document are displayed in the second area of the page. With this technical solution, in a case that the user searches for a document, information of the document, an association relationship between the document and other documents, and information of a document which is in the association relationship with the document are all displayed. Therefore, the user is enabled to view the association relationship of the document that the user is searching for and other documents while viewing the document that the user is searching for. Thereby, the user can view other documents associated with the document obtained through searching pointedly based on the association relationship, and user experience is improved.

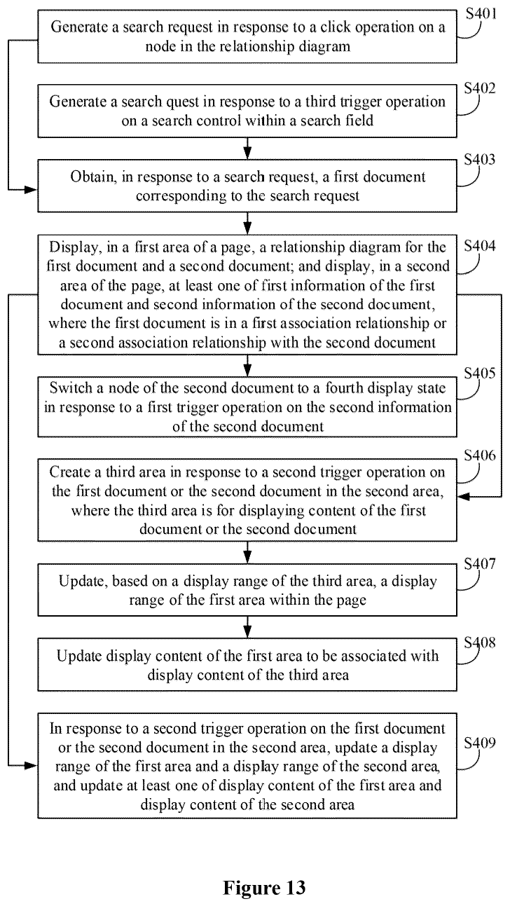

FIG. 13 is a flowchart of a method for searching for a document according another embodiment of the present disclosure. The solution in this embodiment may be combined with one or more optional solutions in the above embodiments. In en implementation, the method for searching for a document further includes: switching a node of the second document to a fourth display state in response to a first trigger operation on the second information of the second document.

In an embodiment, the method for searching for a document further includes: creating a third area in response to a second trigger operation on the first document or the second document in the second area, where the third area is for displaying content of the first document or the second document; and updating, based on a display range of the third area, a display range of the first area within the page.

In an embodiment, the method for searching for a document further includes: updating display content of the first area to be associated with display content of the third area.

In an embodiment, the method for searching for a document further includes: in response to a second trigger operation on the first document or the second document in the second area, updating a display range of the first area and a display range of the second area, and updating at least one of display content of the first area and display content of the second area.

In an embodiment, the method for searching for a document further includes: generating a search request in response to a click operation on a node in the relationship diagram; and/or generating a search quest in response to a third trigger operation on a search control within a search field.

As shown in FIG. 13, the method for searching for a document includes the following steps S401 to S409.

In S401, a search request is generated in response to a click on a node in a relationship diagram, and the method proceeds to S403.

In an embodiment, the user may instruct the electronic device to search for the document by clicking on the node of the document in the relationship diagram. In an implementation, when the user wants to search for a document from a document space, the user may control the electronic device to display a relationship diagram of the document space and click on the node of the document in the relationship diagram. On detecting that the user clicks on the node in the relationship diagram, the electronic device may generate a search request for the document to which the node belongs.

In S402, a search request is generated in response to a third trigger operation on a search control within a search field.

The third trigger operation may be understood as an operation for triggering the search control, such as the user clicking on the search control or the user pressing an enter key alter selecting a document name.

In an embodiment, the user may instruct the electronic device to search for the selected document by triggering the search control. In an implementation, the user triggers the search control after selecting document identification information of a certain document or entering the document identification information into the search field. On detecting that the user triggers the search control, the electronic device may confirm receipt of the third trigger operation and generate a search operation for the document corresponding to the selected document identification information in response to the third trigger operation. In addition, in response to the third trigger operation, the electronic device may further input the document identification information selected by the user into the search field and stop displaying document identification information of each matched document.

In an embodiment, the electronic device may enter a keyword into the search field on the relationship diagram page for displaying the relationship diagram or into the search filed on another page, so as to perform document search. In a case of searching for the document by entering the keyword in the search field on the relationship diagram page, the user selects document identification information that matches the inputted keyword, and the electronic device may further identify, in the relationship diagram, the node of the document to which the document identification information selected by the user belongs. Thereby, the user can easily distinguish the document. In a preferred embodiment, the method for searching for a document may further include: in response to a keyword input operation by a user, displaying, in the search field, a keyword inputted by the user, and displaying document identification information of a matched document that matches the keyword; and receiving a selection operation on document identification information of a target matched document, and switching a node of the target matched document to a fifth display state. The matched document may be understood as a document that matches the keyword inputted by the user. The fifth display state may be the same as or different from the first display state, the second display state, or the third display state, preferably being different from each of the first display state, the second display state, and the third display state. For example, a node in the fifth display state has different shape and/or color from the node corresponding to the first display state, the second display state, or the third display state. The document identification information may include information such as a document name and/or a document ID. The following description is made by taking an example in which the document identification information is the document name.

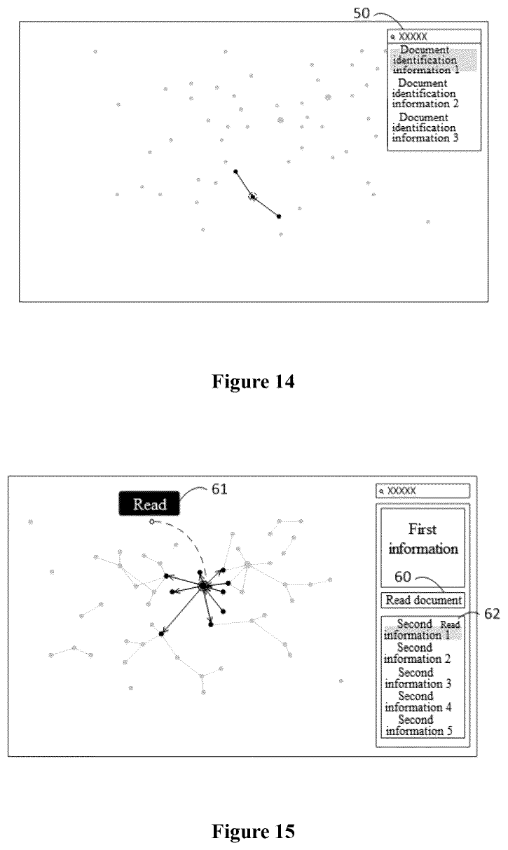

Reference is made to FIG. 14. For example, a search field 50 may be set in the relationship diagram page. When a user wants to search for a certain document, the user may input a keyword of the document (including input of a document name) into the search field 50. The electronic device applies a preset matching algorithm (such as character matching or fuzzy matching) to match a document with the keyword inputted by the user in the search field 50, and display document identification information of the matched document in a preset position (for example, below the search field 50). Thereby, the user can select the document identification information to be searched for to trigger a search control and perform searching. On detecting that the document identification information is selected by the user, the electronic device may switch the node of the document (i.e., the target matched document) corresponding to the identification information selected by the user in the relationship diagram to the fifth display state, and may further display the node of the document that has a first association relationship or second association relationship with the target matched document in the second display state, and display a node other than the node of the target matched document and the node of the document that has a first association relationship or second association relationship with the target matched document in the third display state. Thereby, the user can determine the document that has a first association relationship or second association relationship with the document that the selected document identification information belongs.

In S403, a first document corresponding to the search request is obtained in response to the search request.

In S404, a relationship diagram for the first document and a second document is displayed in a first area of a page, and at least one of first information of the first document and second information of the second document is displayed in a second area of the page. The method proceeds to S405, S406, or S409. The first document is in a first association relationship or a second association relationship with the second document.

In S405, the node of the second document is switched to a fourth display state in response to a first trigger operation on the second information of the second document. Then the operation terminates.

The first trigger operation may be understood as an operation of triggering the second information of the second document displayed in the second area, such as moving the focus to the second information or clicking on the second information. The fourth display state may be a display state that is the same as or different from the first display state, the second display state, or the third display state, preferably being different from the first display state, the second display state, or the third display state. For example, a node may be displayed in a color (such as yellow) different from the color of a node in the first display state, the second display state, or the third display state and/or may be displayed in a shape (such as circle) different from the shape of a node in the first display state, the second display state, or the third display state, which is not limited in the embodiment.

In an implementation, when the user wants to view the association relationship between a second document and another document, the user may trigger the second information of the second document by performing the first trigger operation. On detecting the trigger operation on the second information of the second document, the electronic device may switch the node of the second document to the fourth display state and further display the relationship path between the first document and the second document in a pre-set path display manner, such as using a dashed line without path direction information, so that the user can distinguish the second document triggered by the user, as shown in FIG. 15.

In S406, a third area is created in response to a second trigger operation on the first document or the second document in the second area, where the third area is for displaying content of the first document or the second document.

The second triggering operation may be a trigger operation for viewing content of the first document or content of the second document, such as clicking on a reading control for a certain document. The reading control may be displayed in the relationship diagram and/or the second area. In this case, the method provided in a preferred embodiment may further include: in response to the first trigger operation, displaying, in the relationship diagram, a first reading control for the second document, for the user to perform the second trigger operation; and/or in response to the first trigger operation, displaying, in the second area, the second reading control for the second document, for the user to perform the second trigger operation.

In an embodiment, on receiving the second trigger operation on the first document or the second document, the electronic device may create a new area (i.e., a third area) and display the content of the document in the third area correspondingly.

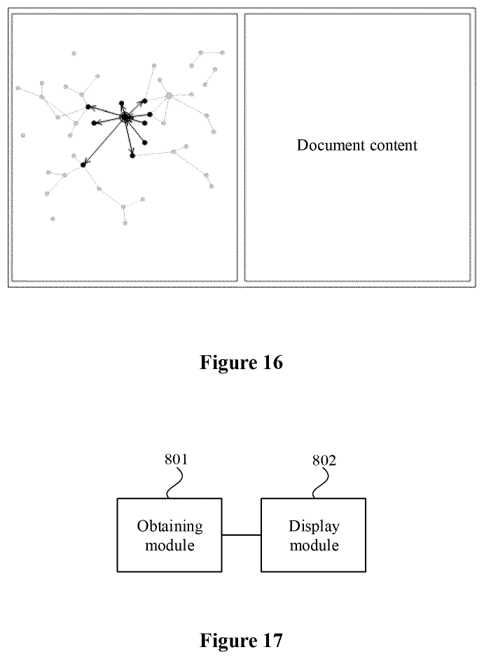

Reference is further made to FIG. 15. An example in which the user triggers a first entry of the second information is taken for the following description. The electronic device displays a reading control 60 for the first document in the second area. On receiving the first trigger operation for the second information of a certain second document, the electronic device displays a first reading control 61 for the second document in the first area and/or displays a second reading control 62 for the second document in the second area. Therefore, the user may click on the reading control 60 for the first document when wants to view the content of the first document, and/or click on the first reading control 61 or the second reading control 62 when wants to view the content of the second document. As shown in FIG. 16, on detecting that the user clicks on the reading control 60 for the first document, the electronic device creates a third area on the page and displays the content of the first document in the third area. On detecting that the user clicks on the first reading control 61 or the second reading control 62 for the second document, the electronic device creates the third area on the page and display the content of the second document in the third area.

In S407, the display range of the first area on the page is updated based on the display range of the third area.

As an example, the third area may be created based on a preset shape and/or size, and the display range of the first area may be further adjusted based on the display range of the third area. For example, the display range of the first area may be reduced based on the display range of the third area to display both the first area and the third area on the page, that is, to display both the relationship diagram and corresponding document content on the page. Thereby, the user can easily view the association relationships between documents or instruct the electronic device to search for a document by clicking on a node in the relationship diagram.

In an embodiment, the display range of the first area and the display range of the third area may be the same as or different from each other. Preferably, the display ranges may be the same so that the user can clearly view the relationship diagram and the document content. In this case, a process of updating, based on the display range of the third area, the display range of the first area in the page includes: displaying both the first area and the third area in a display-allowed area of the page, where the display range of the first area is the same as the display range of the third area. The display-allowed area of the page may be an area where the entire page is located, or may be an area other than a border, a function bar, and other areas in the page.

In S408, display content of the first area is updated to be associated with display content of the third area, and then the operation terminates.

In an embodiment, in response to the second trigger operation on the first document or the second document in the second area, the electronic device may further update the display content of the first area. For example, the electronic device may update a size of the relationship diagram displayed in the first area, the number of nodes displayed in the first area, and/or a display state of each node in the first area, so as to associate the display content of the first area with the display content of the third area. Thereby, the user can easily view the nodes in the first area corresponding to documents to which the display content in the third area belongs and the association relationship of the documents.

For example, to update the display content of the first area, the electronic device may adjust the size of the relationship diagram to completely display the diagram in the first area, or to display only partial content of the relationship diagram in the first area, including the node of the first document and/or a node of a document corresponding to the display content in the third area. The electronic device may further display the node of the document corresponding to the display content in the third area in the first display state, the fourth display state, or any other display state, and display the document having the first/second association relationship with the document corresponding to the display content in the third area in the second display state or the third display state.

In S409, in response to a second trigger operation on the first document or the second document in the second area, a display range of the first area and a display range of the second area are updated, and at least one of display content of the first area and display content of the second area is updated.

In an embodiment, the electronic device may directly display content of a corresponding document in the second area on receiving the second trigger operation on the first document or the second document.

Reference is further made to FIG. 15. An example in which the user triggers a first entry of the second information is taken for the following description. The electronic device displays a reading control 60 for the first document in the second area. On receiving the first trigger operation for the second information of a certain second document, the electronic device displays a first reading control 61 for the second document in the first area and/or a second reading control 62 for the second document in the second area. Therefore, the user may click on the reading control 60 for the first document when wants to view the content of the first document, and/or click on the first reading control 61 or the second reading control 62 when wants to view the content of the second document. As shown in FIG. 16, on detecting that the user clicks on the reading control 60 for the first document, the electronic device may update the display range of the first area and the display range of the second area, and display the content of the first document in the second area and/or update the display content of the first area. On detecting that the user clicks on the first reading control 61 or the second reading control 62 for the second document, the electronic device may update the display range of the first area and the display range of the second area, and display the content of the first document in the second area and/or update the display content of the first area.

In an embodiment, the electronic device may update the display content of the first area. For example, the electronic device may update the size of the relationship diagram displayed in the first area, the number of nodes displayed in the first area, and/or a display state of each node in the first area, so as to associate the display content of the first area with the display content of the second area. Thereby, the user can easily view the nodes in the first area corresponding to documents to which the display content in the third area belongs and the association relationship of the documents. Preferably, the updating the display content of the first area includes updating the display content of the first area to be associated with the display content of the second area.

For example, to update the display content of the first area, the electronic device may adjust the size of the relationship diagram to completely display the diagram in the first area, or to display only partial content of the relationship diagram in the first area, including the node of the first document and/or a node of a document corresponding to the display content in the second area. The electronic device may further display the node of the document corresponding to the display content in the second area in the first display state, the fourth display state, or any other display state, and display the document having the first/second association relationship with the document corresponding to the display content in the second area in the second display state or the third display state.

In this embodiment, the display range of the first area and the display range of the second area may be updated based on a preset shape and/or size. For example, the display range of the second area may be increased. The display range of the first area may be further reduced based on the increased display range of the second area, so as to display both the first area and the second area on the page, that is, to display both the relationship diagram and corresponding document content on the page. Thereby, the user can easily view the association relationships between documents or instruct the electronic device to search for a document by clicking on a node in the relationship diagram.

In an embodiment, after the update, the first area and second area may have the same or different display range, preferably having the same display range, so that it is ensured that user can clearly view the relationship diagram and the document content. In this case, the updating the display range of the first area and the display range of the second area may include: displaying, both the first area and the second area in a display-allowed area of the page, where the display range of the first area is the same as the display range of the second area.

It is understood that in a case that the focus is moved to a display position of the second information of the second document, the second reading control for the second document may be displayed in the second area without switching the display state of each node in the relationship diagram. In a case that the user clicks on the display position of the second information of the second document, the node of the second document is switched to the fourth display state and the first reading control for the second document is displayed. In a case that the user triggers the first reading control or the second reading control for the second document, the electronic device confirms reception of the second trigger operation on the second document and responds to the second triggering operation.

In the method for searching for a document provided in the embodiments, the document search is performed based on the click operation on the node in the relationship diagram and/or the trigger operation on the search control; the relationship diagram for the first document and the second document having the association relationship with the first document, the first information of the first document, and the second information of the second document obtained through searching are displayed; content displayed in the relationship diagram is updated synchronously while the user perform different trigger operations on the first information of the first document or the second information of the second document displayed in the second area. Thereby, multiple convenient search methods are provided to the user, and the user is allowed to view the association relationship of the documents while triggering the document information or viewing the document content. Therefore, user experience is improved.

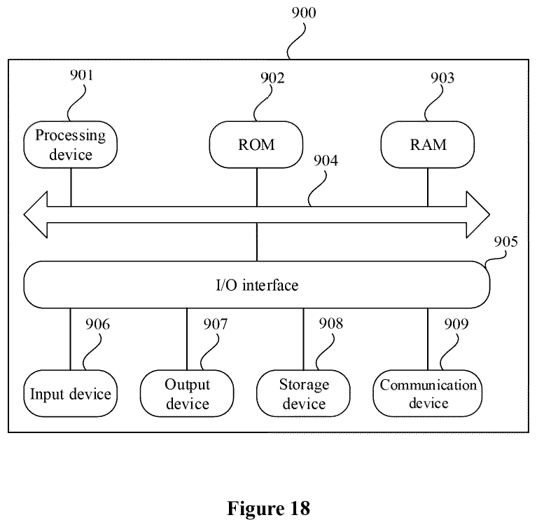

FIG. 17 is a structural block diagram of an apparatus for searching for a document according to an embodiment of the present disclosure. The apparatus may be implemented by software and/or hardware, and may be configured in an electronic device. Typically, the apparatus may be configured in a computer device, and is able to perform document research by directing to the apparatus for searching for a document. Reference is made to FIG. 17. The apparatus for searching for a document according to an embodiment may include an obtaining module 801 and a display module 802.

The obtaining module 801 is configured to obtain, in response to a search request, a first document corresponding to the search request.

The display module 802 is configured to display, in a first area of a page, a relationship diagram for the first document and a second document, and display, in a second area of the page, at least one of first information of the first document and second information of the second document, where the first document is in a first association relationship or a second association relationship with the second document.

With the apparatus for searching for a document according to the embodiments of the present disclosure, the first document corresponding to the search request is obtained in response to the search request; a relationship diagram for the first document and a second document is displayed in the first area of the page, where the first document is in a first association relationship or a second association relationship with the second document; and first information of the first document and second information of the second document are displayed in the second area of the page. With this technical solution, in a case that the user searches for a document, information of the document, an association relationship between the document and other documents, and information of a document which is in the association relationship with the document are all displayed. Therefore, the user is enabled to view the association relationship of the document that the user is searching for and other documents while viewing the document that the user is searching for. Thereby, the user can view other documents associated with the document obtained through searching pointedly based on the association relationship, and user experience is improved.

In the above solution, the first document may be in the first association relationship with the second document, and the display module 802 may be configured to: display, in the relationship diagram, a node of the first document in a first display state, a node of the second document in a second display state, and a node other than the node of the first document or the node of the second document in a third display state.

In the above solution, the first document may be in the second association relationship with the second document, and the display module 802 may be configured to: display, in the relationship diagram, a node of the first document in a first display state, a node of a third document in a second display state, and a node other than the node of the first document or the node of the third document in a third display state, where the first document is in the first association relationship with the third document, and the node other than the node of the first document or the node of the third document includes a node of the second document.

In the above solution, the display module 802 may be further configured to: display a first association path connecting the node of the first document and the node of the second document in a first connection state, where the first connection state includes path direction information of the first association path, and the first connection state has a first path display state.

According to an embodiment, the apparatus for searching for a document may further include a first response module. The first response module is configured to: after the relationship diagram for the first document and a second document is displayed in the first area of the page, and in response to a focus moving to a node of a target document other than the node of the first document, display the node of the target document in the second display state, and display a second association path connecting the node of the target document and a node of a fourth document in a second connection state, where the target document is in the first association relationship or the second association relationship with the fourth document, the second connection state includes path direction information of the second association path, and the second connection state has a second path display state.

In the above solution, the first association relationship may be a reference relationship, and the second association relationship may be a recommendation relationship; or the first association may be a recommendation relationship, and the second association may be a reference relationship; where the reference relationship includes at least one of a forward reference relationship and a reverse reference relationship.

According to an embodiment, the apparatus for searching for a document may further include a second response module. The second response module is configured to: switch a node of the second document to a fourth display state in response to a first trigger operation on the second information of the second document.

According to an embodiment, the apparatus for searching for a document may further include a third response module and a range update module. The third response module is configured to: create a third area in response to a second trigger operation on the first document or the second document in the second area, where the third area is for displaying content of the first document or the second document. The range update module is configured to update, based on a display range of the third area, a display range of the first area within the page.

In the above solution, the range update module may be configured to: display both the first area and the third area in a display-allowed area of the page, where the first area and the third area have a same display range.

According to an embodiment, the apparatus for searching for a document may further include a content update module. The content update module is configured to: update display content of the first area to be associated with display content of the third area.

According to an embodiment, the apparatus for searching for a document may further include a fourth response module. The fourth response module is configured to: in response to a second trigger operation on the first document or the second document in the second area, update a display range of the first area and a display range of the second area, and update at least one of display content of the first area and display content of the second area.

In the above solution, the fourth response module may be configured to: display both the first area and the second area in a display-allowed area of the page, where the display range of the first area is the same as the display range of the second area.

In the above solution, the fourth response module may be configured to: update the display content of the first area to be associated with the display content of the second area.

According to an embodiment, the apparatus for searching for a document may further include a first generation module and/or a second generation module. The first generation module is configured to generate a search request in response to a click operation on a node in the relationship diagram. The second generation module is configured to: generate a search quest in response to a third trigger operation on a search control within a search field.

According to an embodiment, the apparatus for searching for a document may further include an information display module and a state switching module. The information display module is configured to: in response to a keyword input operation by a user, display, in the search field, a keyword inputted by the user, and display document identification information of a matched document that matches the keyword. The state switching module is configured to receive a selection operation on document identification information of a target matched document, and switch a node of the target matched document to a fifth display state.

The apparatus for searching for a document provided in the embodiments of the present disclosure can implement the method for querying a relationship of documents provided in the embodiments of the present disclosure, and has functional modules and beneficial effects corresponding to execution of the method for searching for a document. Technical details not fully described in these embodiments may be found in the method for searching for a document provided in any of the embodiments of the present disclosure.

Reference is made to FIG. 18, which shows a schematic structural diagram of an electronic device 900 (for example, a terminal device) suitable for implementing the embodiments of the present disclosure. The terminal device in the embodiments of the present disclosure may include but not limited to mobile terminals such as a mobile phone, a notebook computer, a digital broadcast receiver, a personal digital assistance (PDA), a tablet computer (PAD), a portable multi-media player (PMP) and a vehicle terminal (such as a vehicle navigation terminal); and fixed terminals such as a digital TV and a desktop computer. The electronic device shown in FIG. 18 is merely an example, and is not intended to limit functions and scope of the embodiments of the present disclosure.

As shown in FIG. 18, the electronic device may include a processing apparatus (such as a central processor and a graphic processor) 901. The processing apparatus may perform various appropriate actions and processing based on programs stored in a read-only memory (ROM) 902 or programs loaded from a storage device 906 to a random access memory (RAM) 903. Various programs and data required for operations of the electronic device 900 are stored in the RAM 903. The processing apparatus 901, the ROM 902 and the RAM 903 are connected to each other through a bus 904. An input/output (I/O) interface 905 is connected to the bus 904.

Generally, the following components are connected to the I/O interface 905; an input device 906 such as a touch screen, a touch panel, a keyboard, a mouse, a camera, a microphone, an accelerometer, and gyroscope; an output device 907 such as a liquid crystal display (LCD), a loudspeaker and a vibrator; a storage device 906 such as a magnetic tape and a hard disk; and a communication device 909. The communication device 909 may allow the electronic device 900 to communicate with other devices in a wired or wireless manner to exchange data. Although FIG. 18 shows the electronic device 900 provided with various apparatuses, it should be understood that not all shown apparatuses are necessary. Alternatively, more or less apparatuses may be implemented or included.

According to the embodiments of the present disclosure, a process described in the flowchart may be implemented by computer software programs. For example, according to an embodiment of the present disclosure, a computer program product including computer program carried on a non-transitory computer readable medium is provided. The computer program includes program codes for performing the method shown in the flowchart. In such embodiment, the computer program may be downloaded and installed from the network through the communication apparatus 909, installed from the storage apparatus 906 or installed from the ROM 902. The computer program, when executed by the processing apparatus 901, performs functions defined in the methods described in the embodiments of the present disclosure.

It should be noted that, the computer-readable medium described in the present disclosure may be a computer readable signal medium, a computer readable storage medium or any combination thereof. The computer readable storage medium may include but not limited to a system, an apparatus or a device in an electric, magnetic, optical, electromagnetic, infrared or a semiconductor form, or any combination thereof. The computer readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof. In the present disclosure, the computer readable storage medium may be a tangible medium including or storing programs. The programs may be used by or in combination with an instruction execution system, apparatus or device. In the present disclosure, a computer readable signal medium may include a data signal in a baseband or propagated as a part of carrier. The computer readable signal medium carries computer readable program codes. The propagated data signal may include but not limited to an electromagnetic signal, an optical signal or any combination thereof. The computer readable signal medium may be any computer readable medium other than the computer readable storage medium. The computer readable signal medium may send, propagate or transmit programs used by or in combination with the instruction execution system, apparatus or device. The program code included in the computer readable medium may be transmitted via any appropriate medium, including but not limited to an electric wire, an optical fiber, radio frequency (RF) or any appropriate combination thereof.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (for example ad hoc peer-to-peer network), and any known network or network to be developed.

The computer readable medium may be included in the electronic device described above, or may exist independently and is not installed in the electronic device.

The computer readable storage medium carries one or more programs. The one or more programs, when being executed by the electronic device, causes the electronic device to: obtain, in response to a search request, a first document corresponding to the search request, display, in a first area of a page, a relationship diagram for the first document and a second document, and display, in a second area of the page, at least one of first information of the first document and second information of the second document, where the first document is in a first association relationship or a second association relationship with the second document.

Computer program codes for performing operations of the present disclosure may be written by using one or more program design language or any combination. The program design language includes but not limited to object-oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowcharts and block diagrams shown in the drawings show a system architecture, function and operation which may be implemented by the system, method and computer program product according to the embodiments of the present disclosure. Each block in the flowcharts or the block diagram may represent a part of a module, a program section or codes including executable instructions for implementing specified logic functions. It should be noted that, in an alternative embodiment, functions denoted in the blocks may be performed in an order different from the order denoted in the drawing. For example, operations in two blocks connected successively may be performed in parallel, or may be performed in an opposite order, depending on the involved function. It should be noted that, each block in the block diagrams and/or flowcharts, and a combination of blocks in the block diagrams and/or flowcharts may be implemented by a dedicated hardware system for performing specified functions or operations, or may be implemented by a combination of dedicated hardware and computer instructions.

Units involved in the embodiments of the present disclosure may be implemented by software or hardware. Names of the module do not limit the module in a certain case.

The functions described above herein may be performed at least partially by one or more hardware logical components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD) and the like.

In the context of the present disclosure, the computer readable medium may be a tangible medium including or storing programs. The programs may be used by an instruction execution system, apparatus or device, or may be used in combination with the instruction execution system, apparatus or device. The machine-readable medium may be a machine-readable signal medium or a machine-readable storage medium. The machine-readable medium may include but not limited to a system, an apparatus or a device in an electric, magnetic, optical, electromagnetic, infrared, or a semiconductor form, or any combination thereof. The machine-readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof.

According to one or more embodiments of the present disclosure, example 1′ provides a method for searching for a document, including:
obtaining, in response to a search request, a first document corresponding to the search request;
displaying, in a first area of a page, a relationship diagram for the first document and a second document; and
displaying, in a second area of the page, at least one of first information of the first document and second information of the second document,
where the first document is in a first association relationship or a second association relationship with the second document.

According to one or more embodiments of the present disclosure, in example 2′ of the method according to example 1′:
the first document is in the first association relationship with the second document, and
the displaying, in a first area of a page, a relationship diagram for the first document and a second document includes
   displaying, in the relationship diagram, a node of the first document in a first display state, a node of the second document in a second display state, and a node other than the node of the first document or the node of the second document in a third display state.

According to one or more embodiments of the present disclosure, in example 3′ of the method according to example 1′:
the first document is in the second association relationship with the second document, and
the displaying, in a first area of a target page, a relationship diagram for the first document and a second document includes:
   displaying, in the relationship diagram, a node of the first document in a first display state, a node of a third document in a second display state, and a node other than the node of the first document or the node of the third document in a third display state, where
   the first document is in the first association relationship with the third document, and the node other than the node of the first document or the node of the third document includes a node of the second document.

According to one or more embodiments of the present disclosure, in example 4′ of the method according to example 2′ or 3′, the displaying, in a first area of a page, a relationship diagram for the first document and a second document further includes:
displaying a first association path connecting the node of the first document and the node of the second document in a first connection state, where the first connection state includes path direction information of the first association path, and the first connection state has a first path display state.

According to one or more embodiments of the present disclosure, example 5′ of the method according to example 2′ or 3′ further includes:
after the displaying, in a first area of a page, a relationship diagram for the first document and a second document, and in response to a focus moving to a node of a target document other than the node of the first document,
   displaying the node of the target document in the second display state, and
   displaying a second association path connecting the node of the target document and a node of a fourth document in a second connection state, where
   the target document is in the first association relationship or the second association relationship with the fourth document,
   the second connection state includes path direction information of the second association path, and
   the second connection state has a second path display state.

According to one or more embodiments of the present disclosure, in example 6′ of the method according to example 1′ or 2′ or 3′:
the first association relationship is a reference relationship, and the second association relationship is a recommendation relationship; or
the first association is a recommendation relationship, and the second association is a reference relationship; where
the reference relationship includes at least one of a forward reference relationship and a reverse reference relationship.

According to one or more embodiments of the present disclosure, example 7 of the method according to example 1′ further includes:
switching a node of the second document to a fourth display state in response to a first trigger operation on the second information of the second document.

According to one or more embodiments of the present disclosure, example 8′ of the method according to example 1′ or example 2′ or example 3′ further includes:
creating a third area in response to a second trigger operation on the first document or the second document in the second area, where the third area is for displaying content of the first document or the second document; and
updating, based on a display range of the third area, a display range of the first area within the page.

According to one or more embodiments of the present disclosure, in example 9′ of the method according to example 8′, the updating, based on a display range of the third area, a display range of the first area within the page includes:
displaying both the first area and the third area in a display-allowed area of the page, where the first area and the third area have a same display range.

According to one or more embodiments of the present disclosure, example 10′ of the method according to example 8′ further includes:
updating display content of the first area to be associated with display content of the third area.

According to one or more embodiments of the present disclosure, example 11′ of the method according to example 1′ or 2′ further includes:
in response to a second trigger operation on the first document or the second document in the second area,
   updating a display range of the first area and a display range of the second area, and
   updating at least one of display content of the first area and display content of the second area.

According to one or more embodiments of the present disclosure, in example 12′ of the method according to example 11′, the updating a display range of the first area and a display range of the second area includes:
displaying both the first area and the second area in a display-allowed area of the page, where the display range of the first area is the same as the display range of the second area.

According to one or more embodiments of the present disclosure, in example 13′ of the method according to example 11′, the updating display content of the first area includes: updating the display content of the first area to be associated with the display content of the second area.

According to one or more embodiments of the present disclosure, example 14′ of the method according to example 1′ or 2′ or 3′ or 7′ further includes:
generating a search request in response to a click operation on a node in the relationship diagram; and/or
generating a search quest in response to a third trigger operation on a search control within a search field.

According to one or more embodiments of the present disclosure, example 15′ of the method according to example 14′ further includes:
in response to a keyword input operation by a user,
   displaying, in the search field, a keyword inputted by the user, and
   displaying document identification information of a matched document that matches the keyword; and
receiving a selection operation on document identification information of a target matched document, and switching a node of the target matched document to a fifth display state.

According to one or more embodiments of the present disclosure, example 16′ provides an apparatus for searching for a document, including:
an obtaining module, configured to obtain, in response to a search request, a first document corresponding to the search request; and
a display module, configured to display, in a first area of a page, a relationship diagram for the first document and a second document, and display, in a second area of the page, at least one of first information of the first document and second information of the second document,
where the first document is in a first association relationship or a second association relationship with the second document.

According to one or more embodiments of the present disclosure, example 17′ provides an electronic device, including:
one or more processors; and
a memory storing one or more programs, where
the one or more programs, when executed by the one or more processors, cause the one or more processors to perform the method for searching for a document according to any one of examples 1′ to 15′.

According to one or more embodiments of the present disclosure, example 18′ provides a computer-readable storage medium storing a computer program, where the computer program, when executed by a processor, implements the method for searching for a document according to any one of examples 1′ to 15′.

The preferred embodiments and the technical principles of the present disclosure are described above. It should be understood by those skilled in the art that, the protection scope of the present disclosure is not limited to the technical solutions formed by specific combination of the above technical features, and other technical solutions formed by combinations of the above technical features or equivalent features without departing from the concept of the present disclosure also fall within the protection scope of the present disclosure. For example, the technical solution formed by replacement between the above technical features and technical features with similar functions disclosed (not limited) in the present disclosure also fall within the protection scope of the present disclosure.

Although the operations are described in a specific order, the operations are unnecessarily to be performed in the specific order or in a chronological order. In a certain environment, a multi-task and parallel processing may be beneficial. Although specific details are described above, the details should not be understood as restriction to the scope of the present disclosure. Some features described in the context of different embodiments may be combined in one embodiment. Alternatively, the features described in the context of one embodiment may be implemented in multiple embodiments independently or in any appropriate sub-combination.

Although the subject matter is described by language specific to the structure feature and/or method logic, it should be understood that the subject matter defined in the appended claims is not limited to the specific features or actions described above. The specific features and actions are only schematic implementations of the claims.

1. A method for querying a relationship of documents, comprising:
determining a first document displayed on a target page in response to a document relationship query operation performed by a user on the target page, wherein content of the first document is displayed on the target page;
displaying, in a first area of the target page, a relationship diagram for the first document and a second document; and
displaying, in a second area of the target page, the content of the first document,
wherein the first document is in a first association relationship or a second association relationship with the second document.

2. The method according to claim 1, further comprising:
creating a third area in response to a click operation on a node of any first document displayed in the first area, wherein first information of the first document and second information of a third document are displayed in the third area, and the first document is in the first association relationship or the second association relationship with the third document, and
updating, based on a display range of the third area, a display range of the first area in the target page; or
in response to a click operation on a node of any first document displayed in the first area, updating a display range of the first area and a display range of the second area, and updating display content in the second area to be first information of the first document and second information of a third document, wherein the first document is in the first association relationship or the second association relationship with the third document.

3. (canceled)

4. The method according to claim 2, further comprising:
updating display content in the first area to be associated with display content in a target area for displaying the first information and the second information, wherein
the target area is the second area or the third area.

5. The method according to claim 4, further comprising:
displaying both the first area and the target area in a display-allowed area of the target page.

6. The method according to claim 2, further comprising:
updating a display state of a node of the third document in response to a trigger operation on the second information of the third document.

7. The method according to claim 1, wherein:
the first document is in the first association relationship with the second document, and the displaying, in the first area of the target page, the relationship diagram for the first
document and the second document comprises displaying, in the relationship diagram, a node of the first document in a first display state, a node of the second document in a second display state, and a node other than the node of the first document or the node of the second document in a third display state; or
the first document is in the second association relationship with the second document, and the displaying, in the first area of the target page, the relationship diagram for the first document and the second document comprises displaying, in the relationship diagram, a node of the first document in a first display state, a node of a fourth document in a second display state, and a node other than the node of the first document or the node of the fourth document in a third display state, wherein the first document is in the first association relationship with the fourth document, and the node other than the node of the first document or the node of the fourth document comprises a node of the second document.

8. (canceled)

9. The method according to claim 7, wherein the displaying, in the first area of the target page, the relationship diagram for the first document and the second document further comprises:
displaying a first association path connecting the node of the first document and the node of the second document in a first connection state, wherein the first connection state comprises path direction information of the first association path, and the first connection state has a first path display state.

10. The method according to claim 7, after the displaying, in the first area of the target page, the relationship diagram for the first document and the second document, the method further comprising:
in response to a focus moving to a node of any second document other than the node of the first document,
displaying the node of the second document in the second display state, and
displaying a second association path connecting the node of the second document and a node of a fifth document in a second connection state, wherein
the second document is in the first association relationship or the second association relationship with the fifth document, the second connection state comprises path direction information of the second association path, and the second connection state has a second path display state.

11. The method according to claim 1,
wherein
the first association relationship is a reference relationship, and the second association relationship is a recommendation relationship; or
the first association is a recommendation relationship, and the second association is a reference relationship; wherein
the reference relationship comprises at least one of a forward reference relationship and a reverse reference relationship.

12. The method according to claim 1,
wherein the displaying, in the first area of the target page, the relationship diagram for the first document and the second document, and displaying, in the second area of the target page, the content of the first document comprises:
creating the first area within the target page,
displaying, in the first area, the relationship diagram for the first document and the second document, and
adjusting, based on a display range of the first area, a display range of the second area where the first document is located within the target page.

13. (canceled)

14. An electronic device, comprising:
one or more processors;
a memory storing one or more programs, wherein
the one or more programs, when executed by the one or more processors, cause the one or more processors to perform;
determining a first document displayed on a target page in response to a document relationship query operation performed by a user on the target page, wherein content of the first document is displayed on the target page;
displaying, in a first area of the target page, a relationship diagram for the first document and a second document; and
displaying, in a second area of the target page, the content of the first document,
wherein the first document is in a first association relationship or a second association relationship with the second document.

15. (canceled)

16. A method for searching for a document, comprising:
obtaining, in response to a search request, a first document corresponding to the search request;
displaying, in a first area of a page, a relationship diagram for the first document and a second document; and
displaying, in a second area of the page, at least one of first information of the first document and second information of the second document,
wherein the first document is in a first association relationship or a second association relationship with the second document.

17. The method according to claim 16, wherein:
the first document is in the first association relationship with the second document, and the displaying, in the first area of the page, the relationship diagram for the first document and the second document comprises displaying, in the relationship diagram, a node of the first document in a first display state, a node of the second document in a second display state, and a node other than the node of the first document or the node of the second document in a third display state; or
the first document is in the second association relationship with the second document, and the displaying, in the first area of the page, the relationship diagram for the first document and the second document emprises displaying, in the relationship diagram, a node of the first document in a first display state, a node of a third document in a second display state and a node other than the node of the first document or the node of the third document in a third display state, wherein the first document is in the first association relationship with the third document, and the node other than the node of the first document or the node of the third document comprises a node of the second document.

18. (canceled)

19. The method according to claim 17, wherein the displaying, in the first area of the page, the relationship diagram for the first document and the second document further comprises:
displaying a first association path connecting the node of the first document and the node of the second document in a first connection state, wherein the first connection state comprises path direction information of the first association path, and the first connection state has a first path display state.

20. The method according to claim 17, after the displaying, in the first area of the page, the relationship diagram for the first document and the second document, the method further comprising:
in response to a focus moving to a node of any target document other than the node of the first document,
displaying the node of the target document in the second display state, and
displaying a second association path connecting the node of the target document and a node of a fourth document in a second connection state, wherein
the target document is in the first association relationship or the second association relationship with the fourth document, the second connection state comprises path direction information of the second association path, and the second connection state has a second path display state.

21. The method according to claim 16, wherein
the first association relationship is a reference relationship, and the second association relationship is a recommendation relationship; or
the first association is a recommendation relationship, and the second association is a reference relationship; wherein
the reference relationship comprises at least one of a forward reference relationship and a reverse reference relationship.

22. The method according to claim 16, wherein
the second information of the second document is displayed in the second area of the page, and
the method further comprises:
switching a node of the second document to a fourth display state in response to a first trigger operation on the second information of the second document.

23. The method according to claim 16, further comprising:
creating a third area in response to a second trigger operation on the first document or the second document in the second area, wherein the third area is for displaying content of the first document or content of the second document, and updating, based on a display range of the third area, a display range of the first area within the page;
or
in response to a second trigger operation on the first document or the second document in the second area, updating a display range of the first area and a display range of the second area, and updating at least one of display content of the first area and display content of the second area.

24. The method according to claim 23, wherein
the updating, based on the display range of the third area, the display range of the first area within the page comprises
displaying both the first area and the third area in a display-allowed area of the page, wherein the display range of the first area is the same as the display range of the third area; or
the updating the display range of the first area and the display range of the second area comprises displaying both the first area and the second area in a display-allowed area of the page, wherein the display range of the first area is the same as the display range of the second area.

25. The method according to claim 23, wherein:
the method further comprises updating display content of the first area to be associated with display content of the third area;
or
the updating display content of the first area comprises updating the display content of the first area to be associated with the display content of the second area.

26-28. (canceled)

29. The method according to claim 16, further comprising at least one of the following:
generating a search request in response to a click operation on any node in the relationship diagram; and
generating a search quest in response to a third trigger operation on a search control within a search field.

30. The method according to claim 29, further comprising:
in response to a keyword input operation by a user,
displaying, in the search field, a keyword inputted by the user, and displaying document identification information of a matched document that matches the keyword; and
receiving a selection operation on document identification information of a target matched document, and switching a node of the target matched document to a fifth display state.

31. (canceled)

32. An electronic device, comprising:
one or more processors; and
a memory storing one or more programs, wherein
the one or more programs, when executed by the one or more processors, cause the one or more processors to perform;
obtaining, in response to a search request, a first document corresponding to the search request;
displaying, in a first area of a page, a relationship diagram for the first document and a second document; and
displaying, in a second area of the page, at least one of first information of the first document and second information of the second document,
wherein the first document is in a first association relationship or a second association relationship with the second document.

33. (canceled)
